(19) United States
(12) Patent Application Publication
(10) Pub. No.: US 2024/0179578 A1
(43) Pub. Date: May 30, 2024

(54) METHODS, SYSTEMS, ARTICLES OF MANUFACTURE AND APPARATUS TO MANAGE NETWORK SLICES

(71) Applicant: Intel Corporation, Santa Clara, CA (US)

(72) Inventors: Akhilesh Shivanna Thyagaturu, Tampa, FL (US); Hassnaa Moustafa Ep. Yehia, San Jose, CA (US); Jing Zhu, Portland, OR (US); Karthik Kumar, Chandler, AZ (US); Shu-Ping Yeh, San Jose, CA (US); Henning Schroeder, Karlsruhe (DE); Menglei Zhang, Portland, OR (US); Mohit Kumar Garg, Hisar (IN); Shiva Radhakrishnan Iyer, Sunnyvale, CA (US); Francesc Guim Bernat, Barcelona (ES)

(21) Appl. No.: 18/427,242

(22) Filed: Jan. 30, 2024

(51) Int. Cl. H04W 28/26; H04W 28/02; H04W 28/084

(52) U.S. Cl. CPC H04W 28/26; H04W 28/0268; H04W 28/084

(57) ABSTRACT

Systems, apparatus, articles of manufacture, and methods are disclosed to manage network slices. An example apparatus includes interface circuitry to acquire network information, machine-readable instructions, and at least one processor circuit to be programmed by the machine-readable instructions to reserve first network slices to satisfy service level objectives (SLOs) corresponding to first nodes, reserve second network slices to satisfy SLOs corresponding to second nodes, and reconfigure the first network slices to accept network communications from the second nodes when the network communications from the second nodes exceed a performance metric threshold.

### FIELD OF THE DISCLOSURE

This disclosure relates generally to network bandwidth control and, more particularly, to methods, systems, articles of manufacture and apparatus to manage network slices.

### BACKGROUND

Network performance is affected by any number of conditions, such as network node health and dynamic network user volumes. In view of anticipated degradation of the network node health and/or disparities in a number of network users, network managers incorporate network node redundancies into network infrastructure design.

### BRIEF DESCRIPTION OF THE DRAWINGS

FIG. 1 is a block diagram of an example environment in which example network control circuitry and network control interface circuitry operate to manage network slices in a manner consistent with teachings of this application.

FIG. 2 is a block diagram of an example manufacturing environment in which the example network control circuitry and network control interface circuitry of FIG. 1 operate to manage network slices for user equipment.

FIG. 3 is a block diagram of an example implementation of the network control circuitry of FIG. 1 to manage network slices.

FIG. 4 is a block diagram of an example implementation of the network control interface circuitry of FIG. 1 to manage network slices.

FIG. 5 is a block diagram of an example environment that includes a native radio access network and an assistive autonomous mobile robot node to assist the native radio access network to manage network slices.

FIG. 6 is a block diagram of an example function map corresponding to functions of a radio access network.

FIG. 7 is a timing diagram of example dynamic radio access network function management using the example autonomous mobile robot of FIG. 5.

FIG. 8 is a block diagram of an example hierarchical resource provisioning framework for service level agreement compliance.

FIG. 9 is a graph corresponding to ideal and realistic costs as a function of service level agreement scores.

FIG. 10 is a block diagram of an example multi-access management service (MAMS) framework.

FIG. 11 is a block diagram of example interfaces of an example Internet Engineering Task Force (IETF) network slice controller.

FIG. 12 is a block diagram of an example generic network slicing (GNS) resource management system.

FIGS. 13-15 are flowcharts representative of example machine-readable instructions and/or example operations that may be executed, instantiated, and/or performed by example programmable circuitry to implement the network control circuitry and/or the network control interface circuitry of FIGS. 1-4.

FIG. 16 is a block diagram of an example processing platform including programmable circuitry structured to execute, instantiate, and/or perform the example machine-readable instructions and/or perform the example operations of FIGS. 13-15 to implement the [ER-Apparatus] of FIG. [ER-Diagram].

FIG. 17 is a block diagram of an example implementation of

the programmable circuitry of FIG. 16.

FIG. 18 is a block diagram of another example implementation of the programmable circuitry of FIG. 16.

FIG. 19 is a block diagram of an example software/firmware/instructions distribution platform (e.g., one or more servers) to distribute software, instructions, and/or firmware (e.g., corresponding to the example machine-readable instructions of FIGS. 13-15) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Network services transfer data that traverses any number of individual networks to satisfy one or more objectives of the services. Some services and/or applications facilitate data that is consumed by user equipment (UE), such as wireless telephones that operate in a radio access network (RAN). The RAN may be a first communication hop from the UE to a backhaul network that provides data to/from a core network that is communicatively connected to any number of resources that accomplish the service requested by the UE. For instance, the core network may include any number of data warehouses, servers and/or accelerators that provide web search results, image processing services, artificial intelligence (AI) services, and/or streaming services.

The network services that utilize the one or more networks have particular performance expectations, such as particular bandwidth capabilities, particular image and/or video resolutions, particular jitter metrics, particular packet loss limits, particular speeds, and/or particular latency capabilities. To ensure that the network services perform in a manner consistent with such expectations, service level objectives (SLOs) or service level agreements (SLAs) include metrics that, if satisfied, result in a quality of service (QOS) expected by users. A degree of confidence in satisfying SLO, QoS, and/or SLA metrics may be achieved by allocating resources to the network services and/or nodes that facilitate the network services in a static manner. Stated differently, particular network resources may be allocated in a manner that do not share such resources to services and/or communication flows outside a pre-designated configuration. For instance, a first service to facilitate a communication flow between a first group of network nodes (e.g., UEs corresponding to wireless subscribers) is assigned a designated network slice that accommodates a limited quantity of nodes of the first service. If the designated slice for the first service is relatively lightly utilized, those provisioned resources of the first slice remain unavailable to any other network service(s) so that the QoS expectations do not deteriorate.

Because services are assigned and/or otherwise dedicated to a constant set of resources that are siloed and/or otherwise sequestered from competing services, QoS expectations are satisfied. However, despite the improvements for the services that operate within a dedicated slice, those resources are wasted when the assigned service exhibits relatively low demands (e.g., relatively low bandwidth needs). Even when a competing service exhibits a failure and/or emergency event in known systems, the sequestered slices remain focused to satisfy their designated services and/or applications despite their capabilities to assist with the failure(s). As such, examples disclosed herein address needs for network slicing that accommodate multiple services and/or applications from any number of tenants, in which those different tenants may have any number of SLOs using the same infrastructure.

Examples disclosed herein improve an efficiency of network resources by dynamically modifying resource allocation through dynamic prioritization of traffic and resource assignments. Some examples disclosed herein improve network efficiency in view of heterogenous network capabilities, such as circumstances where relatively high RAN bandwidth capabilities flood and/or otherwise inundate relatively lower backhaul network bandwidth capabilities, particularly when nodes of the RAN experience emergency events that require a data dump to the core network.

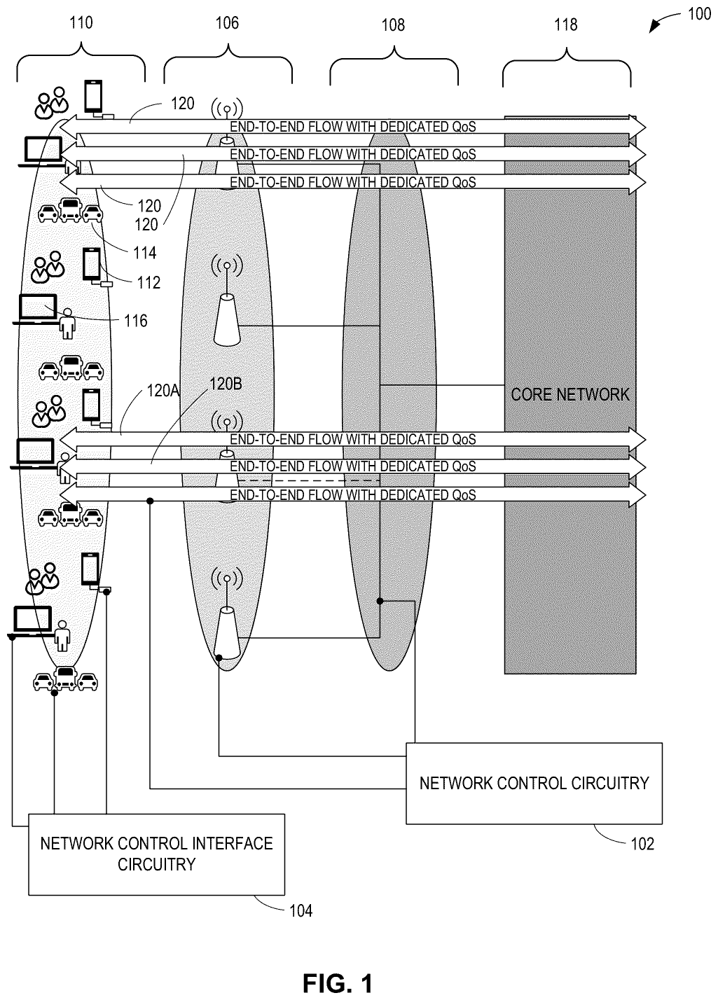

FIG. 1 is an example environment 100 to manage network slices. In the illustrated example of FIG. 1, the environment 100 includes example network control circuitry 102 communicatively connected to one or more radio access networks (RANs) 106 and one or more backhaul networks 108. Because the example network control circuitry 102 is communicatively connected to the RANs 106, the network control circuitry 102 is able to monitor end-to-end flows 120 between any number of UE devices in an example UE pool 110. As used herein, a flow is an information channel that utilizes resources from one or more networks and/or nodes to reach a destination. As used herein, a slice is a subset of network resources across network nodes for an end-to-end connection that accommodate the flow. Example UEs within the UE pool 110 may include, but are not limited to wireless telephones 112, mobile vehicles 114, and computing devices 116, which may include autonomous robotic factory equipment. Respective ones of the UE devices in the example UE pool 110 include example network control interface circuitry 104. The illustrated example of FIG. 1 includes an example core network 118, which may provide any number of services and/or applications to the UE devices of the UE pool 110.

In operation, the end-to-end flows 120 between respective UEs of the UE pool 110 represent slices that are configured to maintain a dedicated quality of service (QOS). An example first flow 120A facilitates communication between one or more UEs of the UE pool 110 that traverses the example RAN 106 and the example backhaul network 108 before ultimately reaching the example core network 118. Similarly, an example second flow 120B facilitates communication between one or more UEs (e.g., different UEs than those associated with the first flow 120A) of the UE pool 110 that traverses the example RAN 106 and the example backhaul network 108 before ultimately reaching the example core network 118. As described in further detail below, in the event the services, applications and/or UEs associated with the first flow 120A experience a failure and/or catastrophic event, a relatively larger amount of data associated with that event may need to be transmitted via the first flow 120A to the core network 118. For instance, in response to a catastrophic event of a UE associated with the first flow 120A, the affected UE and/or participating neighbors of the affected UE may transmit log information, error details and/or any other packets of data associated with the catastrophic event in an effort to troubleshoot one or more causes of that event. In some examples, the core network 118 receives and processes the log information, error details and/or other packets of data using computational resources that are unavailable to relatively less computationally-capable UEs.

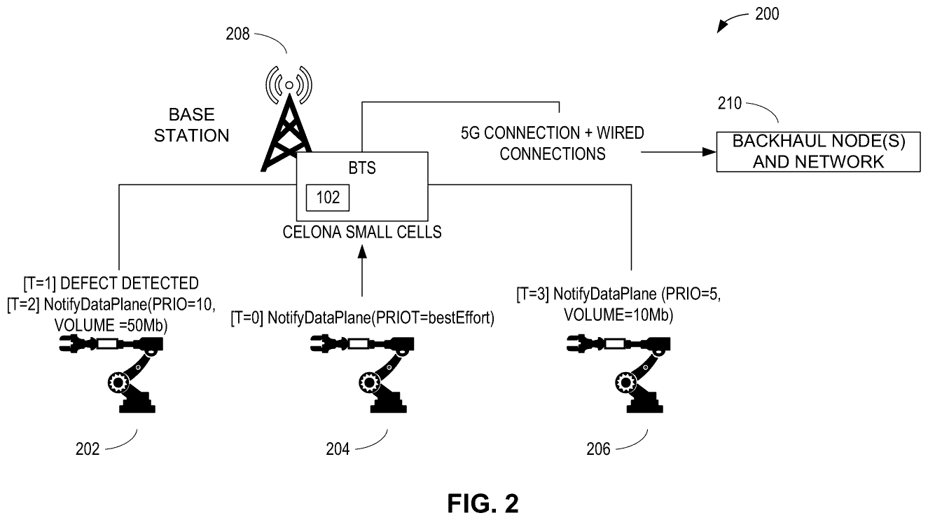

FIG. 2 is an example manufacturing environment 200 in which a UE (e.g., a robotic arm) detects and/or otherwise experiences a defect during process control operations. In the illustrated example of FIG. 2, the environment 200 includes a first UE 202, a second UE 204 and a third UE 206 communicatively connected to an example base transceiver station (BTS) 208. The example first UE 202, second UE 204 and/or third UE 206 may include a robotic arm for manufacturing purposes and/or sensors to monitor any number of manufacturing parameters (e.g., operating temperatures, material qualities, safety switches (e.g., light curtains), etc.). The BTS 208 facilitates a RAN, which is communicatively connected to an example backhaul network/node 210. The example BTS 208 and the example backhaul network 210 are communicatively connected to the example network control circuitry 102. In the illustrated example of FIG. 2, each UE includes corresponding network control interface circuitry 104.

During normal operation when none of the UEs has detected a defect or experienced a fault, the BTS 208 processes and/or otherwise accommodates a first bandwidth containing information from the UEs that is sent to a core network via the example backhaul network 210. In some examples, the UEs operate at a priority level commensurate with a degree of importance of the data being sent to the core network. In some examples, the priority level includes a range of values (e.g., 0 to 10), in which a relatively lower priority level (e.g., 0) causes the UE to send the data with a best effort scheme. In some examples, relatively higher priority levels (e.g., 10) cause the UE to send the data in an urgent manner and at the expense of other data having relatively lower priority levels. In some examples, the information corresponding to normal operation from the UEs is deemed important information, but not necessarily urgent information that is necessary for safety and/or manufacturing losses. For instance, data associated with normal operation may include aggregated statistical information regarding different metrics related to a manufacturing process. In some examples, the information corresponding to normal operation is sent to the core network for indexing and/or trend analysis to aid in future quality improvements, and the rate at which information is collected and sent by the BTS 208 (e.g., the RAN) is within limits that the backhaul network 210 can accommodate.

During operation in which one or more of the UEs detects a defect and/or experiences a fault, the bandwidth demands associated with normal operation are exceeded so that one or more of the UEs can send critical information to the core network via the backhaul network 210. In the illustrated example of FIG. 2, the first UE 202 detects a defect that results in a data dump operation by the first UE 202. Unlike the first UE 202 that increases a bandwidth demand of the RAN, the second UE 204 and the third UE 206 continue to operate under normal conditions in which their contributory bandwidth to the RAN is non-transient. As a result of the data dump by the first UE 202, the backhaul network 210 may become inundated and fail to send critical information corresponding to the data dump to the core network so that corrective action(s) can be implemented. For example, in the event the core network does not receive such critical information in a timely manner, one or more notifications and/or preventative actions may be delayed that could result in injury or property damage. To avoid loss of critical data and/or to otherwise avoid a delay of the critical data, examples disclosed herein employ the network control circuitry 102 and the network control interface circuitry 104 to, in part, reconfigure slices in a dynamic manner.

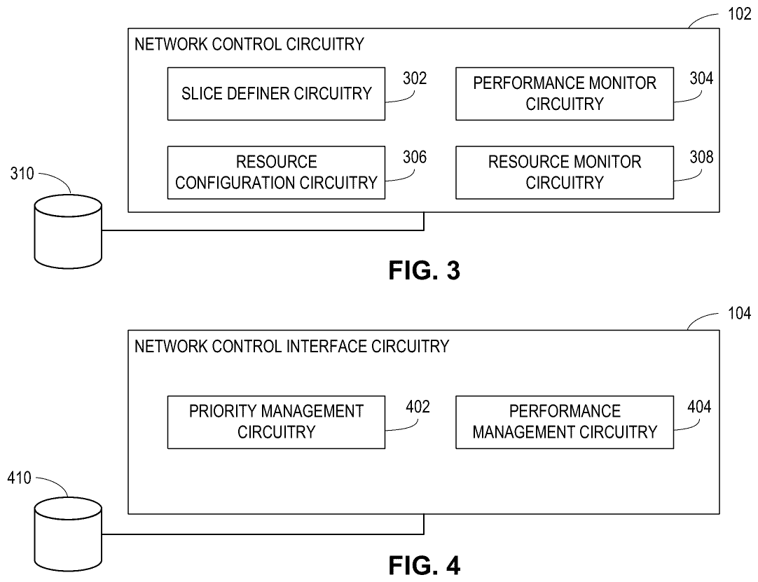

FIG. 3 is a block diagram of an example implementation of the network control circuitry 102 of FIG. 1 to manage network slices. The network control circuitry 102 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the network control circuitry 102 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

FIG. 4 is a block diagram of an example implementation of the network control interface circuitry 104 of FIG. 1 to manage network slices. In the illustrated example of FIG. 4, the network control interface circuitry 104 includes example priority management circuitry 402, example performance management circuitry 404, and example buffer resources 410. In some examples, the buffer resources 410 are included within the example network control interface circuitry 104, and in some examples the buffer resources 410 are communicatively accessible to the network control interface circuitry 104 (e.g., the buffer resources 410 may be part of a system-on-chip, platform, etc.). The network control interface circuitry 104 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the network control interface circuitry 104 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In the illustrated example of FIG. 3, the network control circuitry 102 includes example slice definer circuitry 302, example performance monitor circuitry 304, example resource configuration circuitry 306, example resource monitor circuitry 308, and example buffer resources 310. In some examples, the buffer resources 310 are included within the example network control circuitry 102, and in some examples the buffer resources 310 are communicatively accessible to the network control circuitry 102 (e.g., the buffer resources 310 may be part of a system-on-chip, platform, etc.). In operation, the example slice definer circuitry 302 maps nodes to slices so that QoS and/or SLO objectives are achieved. For example, the slice definer circuitry 302 maps particular UEs (e.g., first UEs) of the example UE pool 110 to a slice, which includes designated network nodes (e.g., routers, switches) to facilitate one or more flows. As such, the behaviors and/or demands of other UEs (e.g., second UEs, third UEs, etc.) does not affect performance metrics of flows corresponding to the first UEs. In some examples, the slice definer circuitry 302 maps such network nodes to pre-allocate computing and/or routing resources to only that traffic that is associated with the first UEs (e.g., particular MAC addresses, particular IP addresses, etc.).

The example performance monitor circuitry 304 monitors performance metrics of the RAN and backhaul networks. Performance metrics include, but are not limited to bandwidth metrics, jitter metrics, packet loss metrics, speed metrics and latency metrics. In the event the performance monitor circuitry 304 detects that the first flow 120A exhibits (e.g., satisfies) a threshold metric indicative of a potential limit or problem, the slice definer circuitry 302 reshapes and/or otherwise reconfigures the corresponding slice and/or other slices to alleviate the problematic conditions for the first flow 120A. To illustrate, consider that the example first flow 120A is configured based on a first slice and the example second flow 120B is configured based on a second slice, and that both the first and second slices configure some or all of the network nodes to accomplish communication from the UE pool 110 to the core network 118. Additionally, consider that the first and the second slices are configured to allocate 50% of each network node resource for the example first flow 120A and the example second flow 120B. As such, any non-use of resources by one of the flows results in unutilized capability that is on-reserve for only the designated flow.

Continuing the example scenario above where a UE corresponding to the first flow 120A exhibits a failure and needs to perform a data-intensive data dump that would inundate the backhaul network 108, the slice definer circuitry 302 determines whether resources corresponding to the second slice can absorb some bandwidth. For instance, if the second flow 120B is determined to have nominal and/or otherwise available resources (e.g., available bandwidth), then the slice definer circuitry 302 reshapes the first slice to allocate additional resources to the first flow 120A and to reduce and/or otherwise constrain resources corresponding to the second flow 120B. By constraining and/or otherwise reducing the resources corresponding to the second flow 120B, which may be associated with a relatively lower priority, the resource burden imposed by the second flow 120B on the backhaul network 108 is reduced.

In addition to (a) reshaping the first slice corresponding to the first flow 120A to borrow and/or otherwise utilize resources from the second slice corresponding to the second flow 120B and (b) reshaping the second slice corresponding to the second flow 120B to reduce resource consumption, the example resource configuration circuitry 306 applies, initiates and/or otherwise instantiates available buffer resources 310 to store data corresponding to the second flow 120B that is being held back in favor of the relatively more critical data corresponding to the first flow 120A. Stated differently, example buffer resources 310 provide temporary relief to the inundated backhaul network when one or more preceding networks exhibit traffic increases, such as circumstances where one or more UEs performs a data dump. When the example performance monitor circuitry 304 determines that the failure or data dump condition has ended, the slice definer circuitry 302 reverts the network slice configurations back to their prior, original and/or otherwise default settings.

While the failure or data dump scenario described above was described in connection with the example network control circuitry 102, in some examples the network control interface circuitry 104 participates to adjust slice configurations from the affected UEs. For example, the priority management circuitry 402 of an affected UE determines whether a priority change has occurred. In some examples, the priority change reflects a circumstance where the UE detects it is approaching or has satisfied a threshold limit of capabilities, beyond which may result in the loss of critical data. In some examples, the priority change reflects a circumstance where the UE is operating within acceptable threshold ranges, but a neighboring UE solicits assistance in view of failures and/or data dumps from the neighboring UE. The example priority management circuitry 402 determines whether the priority change is a request to increase resource utilization or decrease utilization (in favor of reducing a subsequent network path bandwidth burden).

In the event the priority management circuitry 402 detects a UE priority increase, then the network controller interface circuitry 104 transmits a request to the slice definer circuitry 302 for slice reconfiguration before transmitting a payload. In some examples, the network controller interface circuitry 104 waits for an acknowledgement from the example slice definer circuitry 302 to confirm that slice reshaping has occurred before the (e.g., urgent) payload is sent by the affected UE.

In the event the priority management circuitry 402 detects a UE priority decrease, then the performance management circuitry 404 adjusts one or more operating parameters of the UE to reduce its burden on downstream networks, such as the example backhaul network 108 that may be experiencing an inundated state. If available, the example performance management circuitry 404 activates buffer resources 410 to store (e.g., temporarily) data that is to be sent to the core network.

In some examples, autonomous mobile robot (AMR) based dynamic RAN infrastructure scaling facilitates flow management (e.g., switching, shaping, reconfiguration). AMR resources may include, but are not limited to ground-based resources (e.g., ground-based vehicles), air-based resources (e.g., airplanes, helicopters, drones, etc.) and/or water-based resources (e.g., water-based vehicles). AMR resources may operate in different modes, including tethered modes or untethered modes. For instance, a venue may experience an increase in UE service demands corresponding to concert events, sporting events, and the like. An existing RAN infrastructure has fixed physical resources (static) and may not have sufficient capabilities to accommodate such an increase in RAN demand. To address such static resource infrastructures, external equipment (e.g., trucks having RAN resources) is brought into the geographic location to handle the additional UE burdens/demands. Known resources that are physically brought to a geographic location include a RAN and the functions associated therewith, in which deployment of the RAN includes supplemental radio resources and functions that operate as an indivisible infrastructure, even when particular functions within the mobile (e.g., temporary) RAN are not needed.

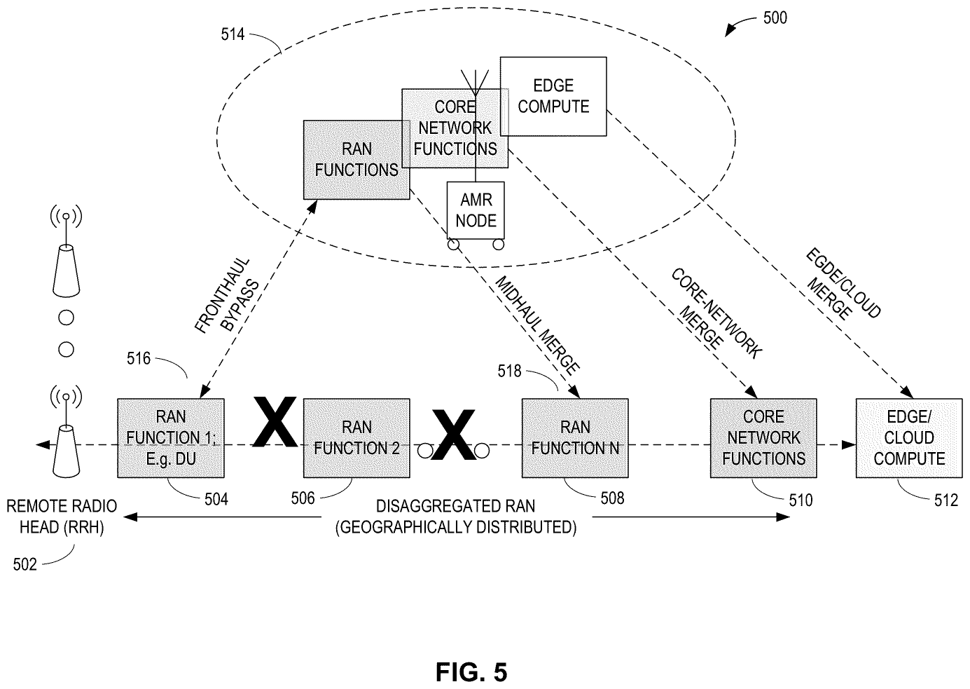

FIG. 5 is an example environment 500 that includes a native RAN 502 and an AMR 514 that may have been placed in the geography based on a need to handle excessive UE demands caused by a large event (e.g., concert, sporting event, etc.). In the illustrated example of FIG. 5, the native RAN 502 includes any number of functions, such as an example first function 504, an example second function 506, and an example third function 508. The example native RAN 502 of FIG. 5 also includes connectivity to core network functions 510, which may be communicatively accessible via one or more backhaul networks. The illustrated example of FIG. 5 also includes connectivity to Edge and/or cloud computing resources 512. In the illustrated example of FIG. 5, the second function 506 of the native RAN 502 is unavailable, but the example first function 504 and the example third function 508 are operational. Known mobile RAN resources, when introduced into the environment 500, replace all of the native RAN 502 functions even when only a subset of RAN functions are disabled, faulty and/or otherwise unavailable.

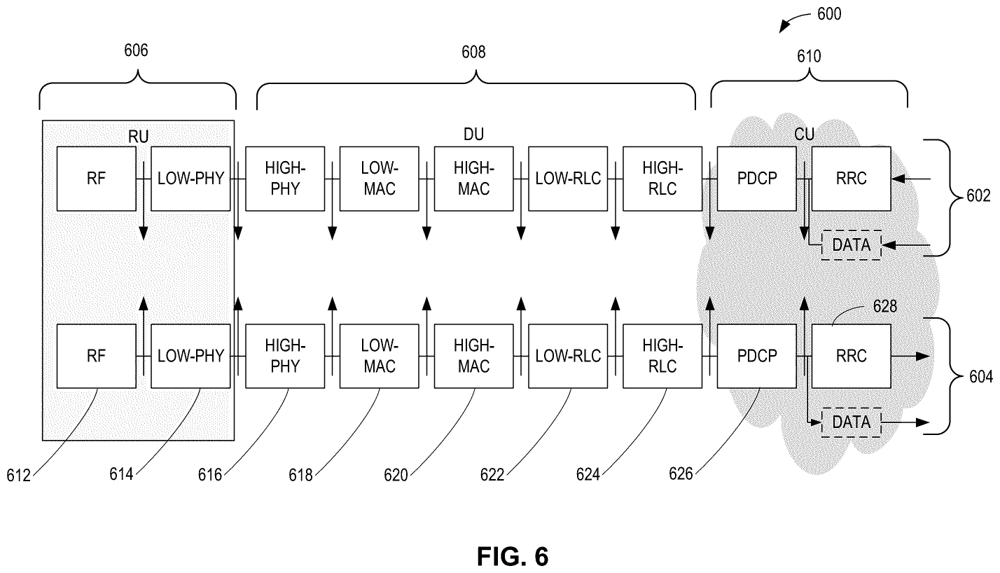

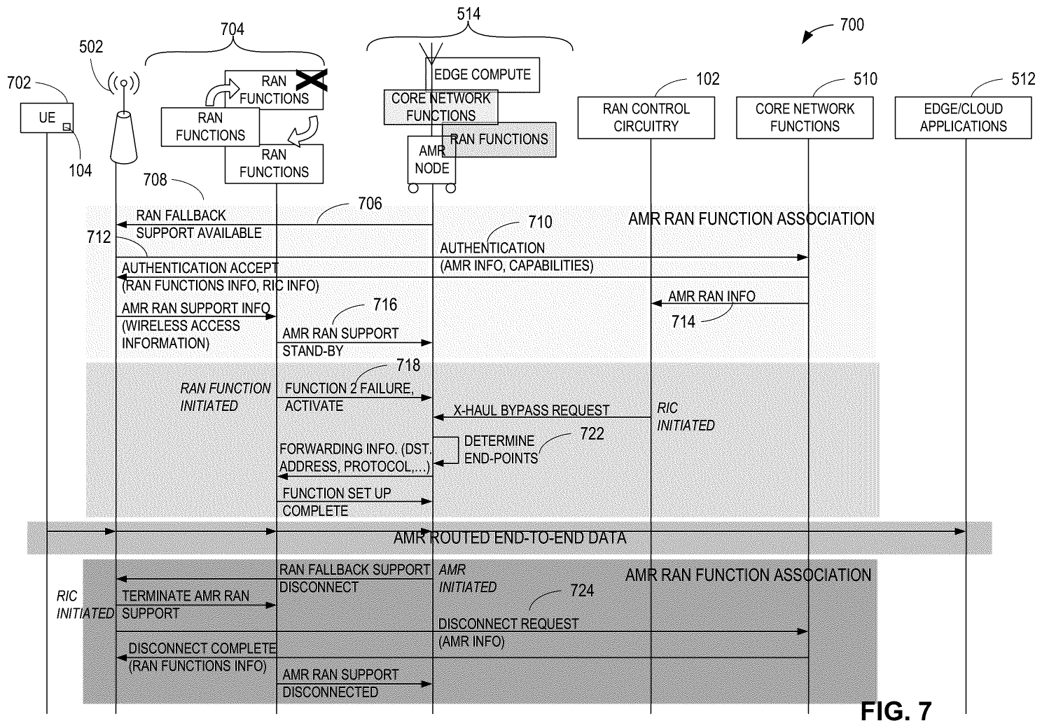

To illustrate, FIG. 6 is an example function map 600 corresponding to functions of a 5G network. While examples described herein include 5G, such examples are illustrative and not limiting. In the illustrated example of FIG. 6, the function map 600 includes incoming functions 602, outgoing functions 604, designated radio unit (RU) functions 606, designated distributed unit (DU) functions 608, and central unit (CU) functions 610. The illustrated example of FIG. 6 includes radio frequency (RF) functions 612, lower physical (LOW-PHY) functions 614, high physical (HIGH-PHY) functions 616, lower MAC functions 618, high MAC functions 620, low radio link controller (RLC) functions 622, high RLC functions 624, packet data convergence protocol (PDCP) functions 626, and radio resource control (RRC) functions 628.

Returning to the illustrated example of FIG. 5, rather than the AMR 514 completely replacing the entirety of the native RAN 502 in the event the example second function 506 exhibits a failure, examples disclosed herein dynamically identify a function bypass entry point 516 to assist with only the one or more functions that need assistance. Additionally, when the AMR 514 of FIG. 5 accomplishes one or more services associated with the failed function, a function merge exit point 518 is identified to allow the native RAN 502 to continue its normal service operation from that point. Accordingly, dynamic bypass and merge RAN function management improves efficiency and lowers costs otherwise associated with the leasing of entire RAN mobile infrastructures.

FIG. 7 is an example timing diagram 700 illustrating dynamic

RAN function slice management. In the illustrated example of FIG. 7, the timing diagram 700 includes an example UE 702, which includes the example network control interface circuitry 104 therein. The illustrated example of FIG. 7 also includes the native RAN 502 and its corresponding RAN functions 704. The illustrated example of FIG. 7 also includes the example AMR 514, the example network control circuitry 102, the example core network functions 510, and the example Edge and/or cloud computing resources 512.

In the event the example AMR 514 is available to the native RAN 502, the existence of which may be revealed via an AMR beacon 706 indicative of a RAN fallback support availability message 708, any number of AMR capabilities and available AMR functions are disclosed to the native RAN 502. The native RAN 502 requests authentication 710 from the core network functions 510 accompanied by a disclosure of the one or more AMR capabilities and AMR functions that may be facilitated by the example AMR 514. The example core network functions 510 accepts the authentication request 712 and shares the AMR RAN information 714 with the example network control circuitry 102. The example native RAN 502 also informs the AMR 514 that it may request particular RAN functions in the future 716.

In response to a failure of one of the RAN functions 718, the example network control circuitry 102 requests that the AMR 514 initiate a bypass 720 of the particular failed function, which includes determining particular end points or merger points 722 for re-introduction to the native RAN 502 when the AMR functions have completed their operations. In some examples, traditional native RAN 502 infrastructure may resume when demand and/or function failures have stopped and a disconnect request is sent to the core network 510 to identify an end to AMR infrastructure support 724.

In some examples, the performance monitor circuitry 304 initiates and/or otherwise continues flow monitoring for the existing native RAN 502 and determines occurrences of RAN function failures. In the event such RAN function failures are detected, the example resource monitor circuitry 308 determines whether AMR resources are available and, if so, registers one or more RAN function bypass points to divert the flow associated with the slice. In some examples, the bypass points and flow diversion are based on learned bottlenecks and/or observed RAN function failures detected and/or communicated by the native RAN 502. The example resource monitor circuitry 308 also invokes AMR RAN functions and merges flows back to the existing native RAN 502 before releasing the one or more AMR RAN functions back to the AMR 514.

As described above, network slicing creates logical networks over a common physical infrastructure with each logical network, (e.g., a “network slice”) configured to support specific use case requirements and business needs. Each network slice is associated with a service-level agreement (SLA) that specifies the required performance target that the network slice should offer. To assure SLA compliance, network slice providers need to properly provision network resources for a network slice.

One type of network slice SLA specifies the real throughput target for a large geographical area. Given a spatial-temporal load variation, a network slice manager configures more resources to high load areas and fewer resources to low load areas to ensure the overall SLA throughput target is met without excessive overprovisioning of network resources. In addition, when spectrum capacity is limited, a network slice manager will need to balance resource allocation between different slices to reduce SLA violation(s). Examples disclosed herein facilitate structure and techniques (e.g., algorithms) for cross-cell inter-slice resource coordination for network slicing.

Examples disclosed herein include resource provisioning algorithms that consider both capacity limitations and traffic load variations for provisioning network resources via policy guidance for network slicing. Stated differently, examples disclosed herein perform predictive analysis of traffic patterns and/or network conditions to aid in the adjustment of radio resource reservations. Additionally, such predictive analysis of traffic patterns and network conditions facilitates movement orchestration and deployment of AMR resources to improve network coverage and capacity in response to real-time and forecasted traffic demands. Without considering capacity limitations, the policy guidance of local throughput targets for all slices may exceed capacity limit of a base station. As a result, local throughput target cannot be met, which will result in SLA violation(s) of large area target data rate.

Operators and/or service providers are introducing new revenue generating services with performance guarantee via network slicing. Intelligent cross-cell inter-slice resource coordination can more efficiently provision network resources to save operation cost and improve energy efficiency.

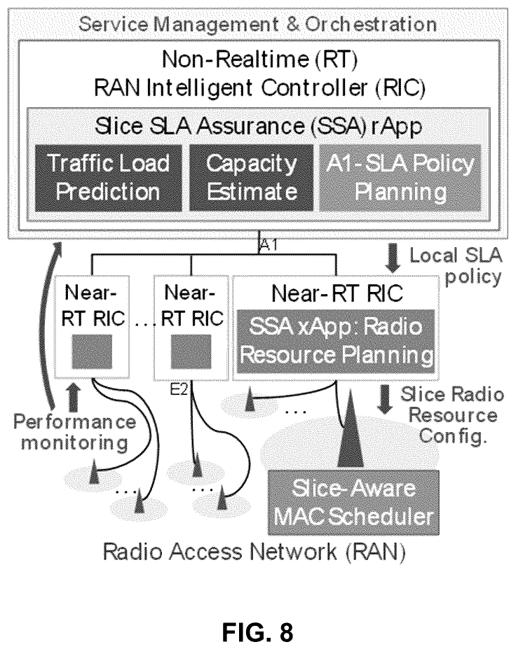

Examples disclosed herein assure SLA compliance by, in part, facilitating a hierarchical framework for slice resource provisioning. Using non-real-time (RT) RAN Intelligent Controllers (RICs), example slice assurance (SSA) rApp are disclosed to calculate ‘Local SLA’ policy for each near-RT RIC coverage area(s). At near-RT RIC, an example SSA-xApp is disclosed that computes the radio resource allocation for different slices based on the guidance provided by the SSA rApp and recent measurements from radio access network (RAN). As shown in FIG. 8, an example hierarchical resource provisioning framework for SLA assurance includes the SSA rApp may incorporate AI/ML models for traffic load prediction and capacity estimation. With the load and capacity estimate of each cell, an example Al-SLA policy planning module will determine the local SLA throughput target to ensure the global SLA throughput target can be met with minimum overprovisioning of resource. In some examples, A1-policy planning algorithms for scenarios where overall slice traffic load within a cell is always below the channel capacity of the cell. Examples disclosed herein include a design of A1-SLA policy planning to coordinate resource sharing across all cells and all slices when capacity limitations are incorporated during planning.

Table 1 illustrates notations corresponding to examples below.

TABLE 1

| Notation | Meaning |
|---|---|
| M | Number of cells (base stations) |
| M | Set of base station identifiers {1, 2, . . . , M} |
| N | Number of slices |
| N | Set of slice identifiers {1, 2, . . . , N} |
| a_{i,j}(t) | Actual traffic load of the j^{th} slice in |
| | the i^{th} cell during time slot t |
| â_{i,j}(t) | Estimated traffic load of the j^{th} slice |
| | in the i^{th} cell during time slot t |
| SLAⱼ | Global service level agreement |
| | throughput target for j^{th} slice |
| cᵢ(t) | Capacity constraint of the i^{th} cell |
| | during time slot t |
| T_{i,j}(t) | Local service level agreement |
| | throughput target for the j^{th} slice in |
| | the i^{th} cell during time slot t |
| βⱼ | Constant service level agreement |
| | violation cost of the j^{th} slice |
| γᵢ | Overprovisioning cost for one unit |
| | of capacity for i^{th} cell |
| ∝_{i,j} | Ratio of βⱼ and γᵢ, interpreted as the |
| | amount of overprovisioned capacity |
| | units that determine a penalty |
| | equivalent to one SLA violation |
| Cⱼ(t) | Actual total cost of allocation for j^{th} |
| | slice at time slot t |
| Ĉⱼ(t) | Estimated total cost of allocation for |
| | j^{th} slice at time slot t |

A first representation of the SLA score for each slice is

determined in a manner consistent with example Equation 1.

rⱼ(t)=Σᵢ₌₁^{M}[min{T_{i,j}(t), a_{i,j}(t)}]−min{SLAⱼ, Σᵢ₌₁^{M}a_{i,j}(t)} Equation 1

The first minimization term represents the actual delivered data rate during time slot t for the j^{th} slice in the i^{th} cell. In some examples, the near-RT RIC SSA xApp calculates a radio allocation for the j^{th} slice in the i^{th} cell that ensures the maximum achievable data rate during time slot t is T_{(i,j)}(t). The actual delivered data rate is thus bounded by the minimum of throughput target T_{(i,j)}(t) and the actual traffic load a_{(i,j)}(t). The second minimization term is the adjusted global SLA throughput after accounting for the actual traffic load within the area.

The SLA score can be used to calculate the monetary cost of SLA violation(s) and overprovisioning. When rⱼ(t)<0, it means that the target SLA throughput guidance T_{(i,j)}(t) fails to achieve the adjusted global throughput SLA and a constant SLA violation cost, βⱼ, will incur. When rⱼ (t)>0, then capacity is overprovisioned to serve slice j traffic and the overprovisioning cost is modeled as linearly increasing with additional capacity provisioned (e.g., cost Cⱼ(t)=γ_{y}·rⱼ;(t). The cost function with respect to SLA score for the j^{th} slice can be summarized in a manner consistent with example Equation 2.

$${C}_{j} ( t ) = \{ \begin{matrix}{β}_{j} , {r}_{j} ( t ) < 0 \\ {γ}_{i} \cdot {r}_{j} ( t ) , {r}_{j} ( t ) \geq 0\end{matrix} . \qquad Equation 2$$

In practice, however, this function is discontinuous at r=0, which creates problems for optimization algorithms that are aimed at minimizing the cost. Also, in some examples Gradient Descent approaches to minimize the cost do not work properly with constant or step functions. Therefore, example modified cost functions disclosed herein optimize target SLA throughput guidance T_{(i,j)}(t). In some examples, a modified cost function includes a negative slope at r=0 to make the function continuous. ∈ is a very small positive constant. In addition, SLA violation cost is no longer constant but slowly increasing with slope ∈, with the gap to target SLA throughput. An example modified cost function is shown in a manner consistent with Equation 3.

$${C}_{j} ( t ) = \{ \begin{matrix}{∝}_{i , j} - ∈ {\hat{r}}_{j} ( t ) if {\hat{r}}_{j} ( t ) \leq 0 \\ {∝}_{i , j} - \frac{1}{∈} {\hat{r}}_{t} ( t ) if 0 < {\hat{r}}_{j} ( t ) \leq ∈ {∝}_{i , j} \\ {\hat{r}}_{j} ( t ) - ∈ {∝}_{i , j} if {\hat{r}}_{j} ( t ) > ∈ {∝}_{i , j}\end{matrix} . \qquad Equation 3$$

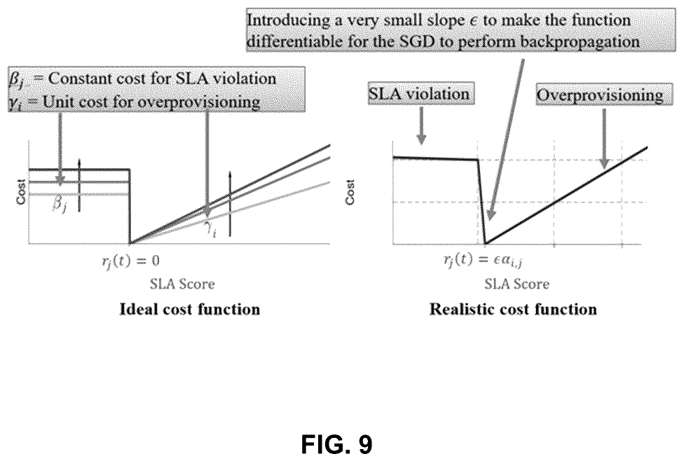

FIG. 9 is a graph corresponding to ideal and realistic costs as a function of the SLA score.

At least one objective for the SSA rApp is to select T_{(i,j)}(t) such that the total cost is minimized. In addition, the local throughput target should not result in violation of capacity constraint for each cell:

Σᵢ^{N}T_{i,j}(t)≤cᵢ(t) Equation 4

If the actual traffic load information is available at non-RT RIC, the overall optimization problem for determining T₍ᵢⱼ₎(t) is shown in a manner consistent with example Equation 5.

$${min}_{\{ {T}_{i , j} ( t ) \}} {\sum }_{j = 1}^{N} {C}_{j} ( t ) where \qquad Equation 5$$

$${r}_{j} ( t ) = {\sum }_{i = 1}^{M} [ min \{ {T}_{i , j} ( t ) , {a}_{i , j} ( t ) \} ] - min \{ SL {A}_{j} , {\sum }_{i = 1}^{M} {a}_{i , j} ( t ) \} , \qquad ∀ j ∈ 𝒩$$

$$subject to {\sum }_{i}^{N} {T}_{i , j} ( t ) \leq {c}_{i} ( t ) , ∀ i ∈ ℳ .$$

However, the actual load information is not available in SSA rApp. The optimization objective will then become minimizing the expected cost given the traffic load estimate, a₍ᵢⱼ₎(t):

$${min}_{\{ {T}_{i , j} ( t ) \}} {E}_{{\hat{a}}_{i , j} ( t )} [ {\sum }_{j = 1}^{N} {C}_{j} ( t ) ] . \qquad Equation 6$$

Due to capacity limitations, RAN nodes controlled by the near-RT RIC may not be able to always achieve the throughput target suggested by non-RT RIC and this can lead to frequent SLA violations. Therefore, a good A1 throughput planning policy should consider both load estimate and capacity limitation to minimize SLA violation.

In the following, we propose multiple load-aware & capacity-aware A1 throughput planning algorithms.

For priority-based A1 throughput planning, an example strategy adjusts the A1 throughput guidance calculated from a load-aware A1 throughput policy by reducing target throughput of lower priority slices when there is capacity violation in a manner consistent with example Equation 7.

$${\sum }_{i}^{N} {T}_{i , j} ( t ) > {c}_{i} ( t ) . \qquad Equation 7$$

In the event the slices are ordered based on their priority, then the lower the slice is the higher the priority (e.g., slice 1 is the highest priority slice) and slice N is the lowest priority slice. The priority of slices can be determined based on the SLA violation cost: slice with a higher SLA violation cost βⱼ will have higher slice priority.

The heuristic priority-based A1 throughput planning algorithm based on load-aware A1 throughput policy can include calculating the target throughput based on a load-aware Al throughput policy in a manner consistent with example Equation 8.

{T_{i,j}^{load-aware}(t)}_{i∈[1˜M],j∈[1˜N]} Equation 8.

Additionally, capacity limit & adjust throughput target for every cell i=1˜M is checked. The current slice is set to j′←N, and the capacity limit is checked. For instance, if Σⱼ₌₁^{j′}T_{i,j}^{load-aware}(t)>cᵢ(t), set T_{i,j′}(t)←max (cᵢ(t)−Σⱼ₌₁^{j′-1}T_{i,j}^{load-aware}(t), 0), and set j′←j′−1. If Σⱼ₌₁^{j ′}T_{i,j}^{load-aware}(t)≤cᵢ(t), then for j=1˜j′, set T_{i,j}(t)←T_{i,j}^{load-aware}(t).

Optimizing based on estimated SLA score considers the actual load information not being available in SSA rApp, so the estimated SLA score, \hat{r}ⱼ, will be used during the optimization process in a manner consistent with example Equation 9.

$${\hat{r}}_{j} ( t ) = {\sum }_{i = 1}^{M} [ min \{ {T}_{i , j} ( t ) , {\hat{a}}_{i , j} ( t ) \} ] - min \{ SL {A}_{j} , {\sum }_{i = 1}^{M} {\hat{a}}_{i , j} ( t ) \} . \qquad Equation 9$$

The estimated cost is denoted as Ĉⱼ(t). The SSA rApp will then try to solve the following optimization problem based on estimated SLA score:

$${min}_{\{ {T}_{i , j} ( t ) \}} {\sum }_{j = 1}^{N} {\hat{C}}_{j} ( t ) where \qquad Equation 10$$

$${\hat{r}}_{j} ( t ) = {\sum }_{i = 1}^{M} [ min \{ {T}_{i , j} ( t ) , {\hat{a}}_{i , j} ( t ) \} ] - min \{ SL {A}_{j} , {\sum }_{i = 1}^{M} {\hat{a}}_{i , j} ( t ) \} , \qquad ∀ j ∈ 𝒩$$

$$subject to {\sum }_{i}^{N} {T}_{i , j} ( t ) \leq {c}_{i} ( t ) , ∀ i ∈ ℳ .$$

The optimization problem is rewritten as the following by introducing two new types of variables: Estimate of actual achieved load A_{i,j}(t) and adjusted global SLA target SLAⱼ^{(adj)}:

$${min}_{\{ {T}_{i , j} ( t ) \}} {\sum }_{j = 1}^{N} {\hat{C}}_{j} ( t ) \qquad Equation 11$$

$$s . t . {\hat{r}}_{j} ( t ) = {\sum }_{i = 1}^{M} {A}_{i , j} ( t ) - S L {A}_{j}^{( a d j )} , ∀ j ∈ 𝒩$$

$${\sum }_{i}^{N} {T}_{i , j} ( t ) \leq {c}_{i} ( t ) , ∀ i ∈ ℳ$$

$${T}_{i , j} ( t ) \geq {A}_{i , j} ( t ) , ∀ i ∈ ℳ , ∀ j ∈ 𝒩$$

$${\hat{a}}_{i , j} ( t ) \geq {A}_{i , j} ( t ) , ∀ i ∈ ℳ , ∀ j ∈ 𝒩$$

$$SL {A}_{j} \geq S L {A}_{j}^{( a d j )} , ∀ j ∈ 𝒩$$

$${\sum }_{i = 1}^{M} {\hat{a}}_{i , j} ( t ) \geq SL {A}_{j}^{( a d j )} , ∀ j ∈ 𝒩 .$$

This optimization problem has linear constraints and a non-convex objective function. There is no closed form solution for this problem, but readily available off-the-shelf constrained optimization approaches may be applied, such as the Trust-Region Constrained Algorithm or the Sequential Least SQuares Programming (SLSQP) algorithm.

Multi-Access Management Services (MAMS) is a programmable framework that provides mechanisms for flexible selection of network paths in a multi-connection (access) communication environment, based on application needs. It leverages network intelligence and policies to dynamically adapt traffic distribution across selected paths and user plane treatment to changing network/link conditions. The network path selection and configuration messages are carried as user plane data between the functional elements in the network and the end-user device, and thus without any impact on the control plane signaling schemes of the individual access network.

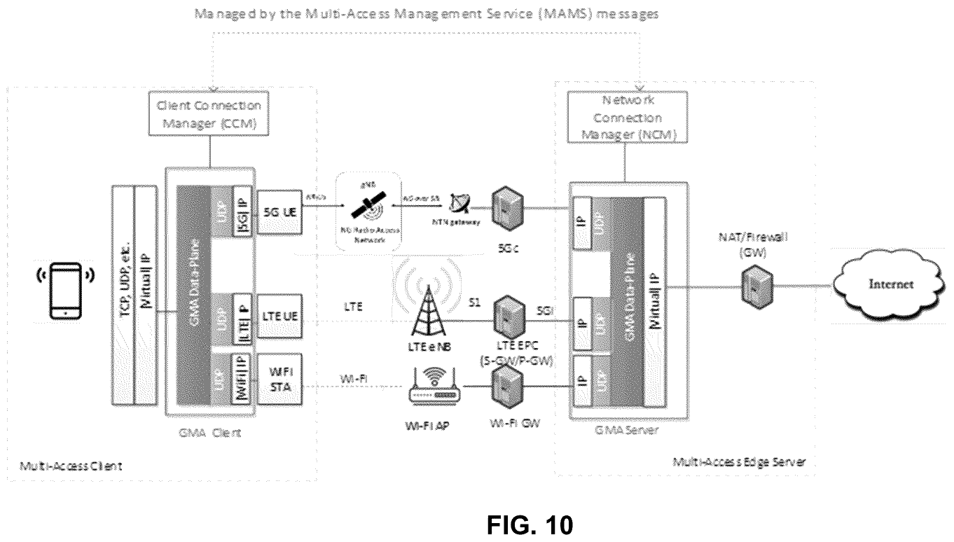

FIG. 10 shows an example multi-access management service (MAMS) framework. In this example, MAMS server runs on the edge, and delivers traffic over multiple connections or paths, e.g. Wi-Fi, LTE/5G, Satellite, etc. A new GMA convergence protocol has been proposed to support multi-path management by adding additional control information (for multi-path management), e.g. sequence number into IP data packet. MAMS improves user experience, e.g. higher throughput, lower latency, and higher reliability, by intelligently splitting/steering/duplicating traffic over multiple connections. However, it remains open how to reserve (isolate) radio resource (also known as Network Slicing) for meeting SLO (service level objectives) of diverse applications with different QoS requirements, in dynamic & unpredictable wireless environment. Examples disclosed herein reserve radio resources for network slicing to meet predetermined SLOs.

Today's network slicing solutions are focused on throughput-based SLO. For example, “Guaranteed Minimum Bandwidth” has been proposed as one of key Service Level Objectives in the IETF network slicing framework. “minDataRate Guarantee” has been used to meet minimum data rate requirement of a slice, and close-loop control is used to adjust per-slice radio resource (e.g. PRB reservation). Examples disclosed herein also predict target data rate based on traffic load, and then adjust per-slice radio resource ratio for minimizing the impact of resource reservation on the system efficiency. However, it is challenging to predict traffic load especially in a private network, where cell coverage is much smaller than a conventional (city-wide) cellular network and user distribution is much more dynamic. Moreover, both unlicensed and licensed spectrum can be used to support the same type of traffic in a private network (thanks to Multi-Access Management Service), and it is even more challenging to predict network capacity in such virtualized multi-access network.

Examples disclosed herein guarantee a minimum share of total (radio) resource for a network slice, which can then be adjusted dynamically based on the minimum throughput target (or data rate) target. The mapping between “Weight” and achievable throughput (data rate) are learned and updated over time via ML/AI algorithms. Network administrators can also directly configure “Weight” instead of Guaranteed Minimum Bandwidth for a network slice to reserve resource in a relative fashion and avoid the impact of other heavily loaded slices.

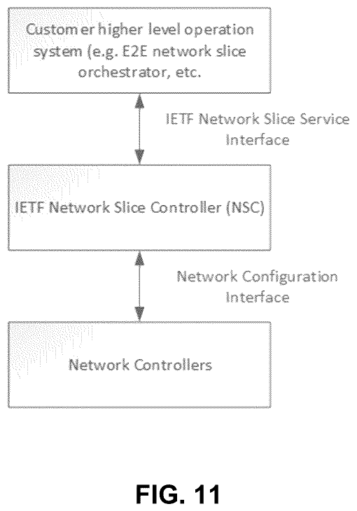

FIG. 11 shows the key interfaces (APIs) of the IETF network slice controller. If the proposed “Wight” parameter (to guarantee the share of resource for a slice) is included in any of the interfaces, particularly the IETF Network Slice Service Interface, it indicates that the proposed idea has been used in the network slice controller.

Below is the list of SLO (Service Level Objectives) defined in IETF network slicing:

Guaranteed Minimum Bandwidth: Minimum guaranteed bandwidth between two endpoints at any time. The bandwidth is measured in data rate units of bits per second and is measured unidirectionally.

Guaranteed Maximum Latency: Upper bound of network latency when transmitting between two endpoints. The latency is measured in terms of network characteristics (excluding application-level latency).

Maximum Permissible Delay Variation: Packet delay variation (PDV) is the difference in the one-way delay between sequential packets in a flow. This SLO sets a maximum value PDV for packets between two endpoints.

Maximum Permissible Packet Loss Rate: The ratio of packets dropped to packets transmitted between two endpoints over a period of time.

Availability: The ratio of uptime to the sum of uptime and downtime, where uptime is the time the connectivity construct is available in accordance with all of the SLOs associated with it. Availability will often be expressed along with the time period over which the availability is measured, and specifying the maximum allowed single period of downtime.

In some examples, the following two new SLO parameters (inspired by the well-known Weighted Round Robin (WRR)-based scheduler) support network slicing in dynamic multi-access wireless networks.

Guaranteed Minimum Resource Ratio: Minimum guaranteed resource ratio between two end points at any time. The resource ratio is measured unidirectionally between 0 and 1. It is also called “Prioritized Minimum Resource Ratio”.

Guaranteed Minimum Resource Weight: A positive integer to indicate the resource allocation weight for a network slice. It measures the minimum guaranteed resource ratio of a slice relative to other slices, e.g., W(i)/W(j)=R(i)/R(j), where W and R indicates the Guaranteed Minimum Resource Weight and Guaranteed Minimum Resource Ratio, respectively.

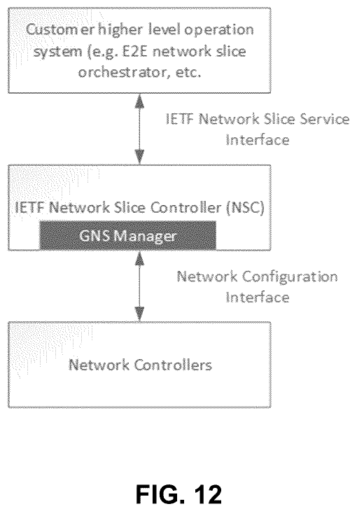

FIG. 12 shows the system diagram for Generic Network Slicing (GNS) resource management system diagram. Here, we propose to include the proposed per-slice SLO (Service Level Objectives) configuration parameter in the IETF network slice service interface, so that the GNS manager can be configured with W(i). The GNS Manger will also collect per-slice resource utilization measurement (u(i)) from (wireless) network controllers, e.g. O-RAN, periodically and then configure the prioritized minimum resource ratio (R(i)) via the network configuration interface.

Examples disclosed herein also include a Generic Network Slicing (GNS) algorithm to dynamically adjust the prioritized radio resource ratio (R) of a slice based on its “Weight” (W) configuration as well as “Utilization” (u) measurement to meet the following objectives:

WRR-based resource isolation: If all the slices are overloaded, the prioritized resource utilization of a slice should be given by

$$\frac{W ( i )}{{\sum }_{i = 1}^{N} W ( i )} L ,$$

where i is slice index, N is the total number of slices, and L is a configuration parameter (≤1) to control how much resource can be prioritized in total. For example, if L=0.8, only 80% of total resource can be prioritized so that at least 20% of total resource is shared among all slices.

Prioritized resource maximization: maximize total effective prioritized resource utilization ratio (r(i)), where “effective prioritized resource utilization ratio” measures how much resource that a slice is using has been prioritized. It is given by min(R(i), u(i)). When a slice uses its prioritized resource, its performance will not be impacted by other slices. Therefore, more prioritized resource utilization leads to higher QoS capacity (the number of flows meeting their QoS requirements).

The GNS algorithm works as follows:

Phase 1 (Initialization):

$$R ( i ) = \frac{W ( i )}{{\sum }_{i = 1}^{N} W ( i )} L ,$$

for all the slices.

Phase 2 (Measurement): perform per-slice utilization measurement (u(i)) to collect statistics and determine per-slice utilization estimate U(i) for the next interval. We can use mean/max/last u(i) measurement for U(i), i.e., U(i)=f(u(i),m), where m is a configuration parameter, e.g., f=u(i)×(l+m), where m=(0, 1].

Phase 3 (Configuration): Adjust R(i) based on U(i) and W(i) as follows:

If Σᵢ₌₁^{N}U(i)<L), then

$$R ( i ) = \frac{U ( i )}{{\sum }_{i = 1}^{N} U ( i )} L .$$

Otherwise divide all the slices into two groups as Group A:

$$U ( i ) \leq \frac{W ( i )}{{\sum }_{i = 1}^{N} W ( i )} L$$

### and Group B:

$$U ( i ) > \frac{W ( i )}{{\sum }_{i = 1}^{N} W ( i )} L .$$

In phase 4 (fine tuning), move all the slices in Group B with R(i)>U(i) to Group A, update R(i) for the two groups the same way as above. Repeat this phase until no slice in Group B has R(i)>U(i).

Example rationale behind each of the phases above is described below. At the very beginning, there is not any information about per-slice resource utilization, and therefore configure R(i) proportional to their weight. Once enough measurements are collected to estimate per-slice utilization ratio U(i), configuration of R(i) considers the following conditions.

First, if the system is underutilized, e.g., Eᵢ₌₁^{N}U(i)<L, examples disclosed herein configure R(i) proportional to their utilization so that all slices can meet their demand with prioritized resource, regardless of their weight. Otherwise, they are divided into two groups. A slice whose utilization is no higher than its configured share

$$\frac{W ( i )}{{\sum }_{i = 1}^{N} W ( i )} L )$$

will be put in Group A, and otherwise in Group B. For the slices in Group A, examples disclosed herein configure R(i) to their estimated utilization ratio (U(i)), since they can't fully utilize all the prioritized resources if configured according to their weight. For Group B, examples disclosed herein configure R(i) proportional to their weight. A finetuning phase (phase 4) is added to avoid any configuration with “R>U”, indicating the prioritized resource is higher than the demand.

The following is an example to illustrate how the proposed GNA algorithm works. Consider 4 network slices with equal weight (W(i)=C, for all i), and L=80%. Thus, R(i)=20% for all 4 slices at the very beginning. Also assume a U(i) trace as shown in Table 2.

TABLE 2

| Time Intervals | 1 | 2 | 3 | 4 | 5 |
|---|---|---|---|---|---|
| Slice A | 10% | 20% | 5% | 15% | 15% |
| Slice B | 20% | 20% | 5% | 5% | 5% |
| Slice C | 35% | 30% | 35% | 35% | 35% |
| Slice D | 30% | 30% | 30% | 28% | 26% |
| Total Utilization | 95% | 100% | 75% | 83% | 81% |

Table 3 shows the Per-slice Prioritized Ratio with the following three configurations of the GNA algorithm (R1, R2, R3) in which R1 represents a static configuration (phase 1 only), R2 represents adaptive configuration without fine tuning (Phases 1-3), and R3 represents adaptive configuration with fine tuning (Phases 1-4).

TABLE 3

| | Time Intervals | | | | |
|---|---|---|---|---|---|
| | 1 | 2 | 3 | 4 | 5 |
| Slice A | 20%, 10%, 10% | 20%, 20%, 20% | 20%, 5.3%, 5.3% | 20%, 15%, 15% | 20%, 15%, 15% |
| Slice B | 20%, 20%, 20% | 20%, 20%, 20% | 20%, 5.3%, 5.3% | 20%, 5%, 5% | 20%, 5%, 5% |
| Slice C | 20%, 25%, 25% | 20%, 20%, 20% | 20%, 37.3%, 37.3% | 20%, 30%, 32% | 20%, 30%, 34% |
| Slice D | 20%, 25%, 25% | 20%, 20%, 20% | 20%, 32%, 32% | 20%, 30%, 28% | 20%, 30%, 26% |

It clearly shows that how the adaptive GNA algorithm can effectively adjust the prioritized resource ratio (R(i)) to accommodate the changing utilization and avoid wasting prioritized resource at time interval 1, 3, 4, and 5. In the meantime, it can guarantee minimum resource share based on the weight when all slices are overloaded at time interval 2. Moreover, with the finetuning phase, the adaptive algorithm can further make adjustments to completely avoid any waste of prioritized resource for slice D at interval 4 and 5 so that more prioritized resource can be allocated to slice C.

Table 4 compares the per-slice effective prioritized resource ratio. It shows that the adaptive configuration especially with fine tuning can successfully maximize prioritized resource ratio at time interval 4 and 5 while still ensure weight-based resource isolation at time interval 2 when all slices are overloaded.

TABLE 4

| | Time Intervals | | | | |
|---|---|---|---|---|---|
| | 1 | 2 | 3 | 4 | 5 |
| Slice A | 10%, 10%, 10% | 20%, 20%, 20% | 5%, 5%, 5% | 15%, 15%, 15% | 15%, 15%, 15% |
| Slice B | 20%, 20%, 20% | 20%, 20%, 20% | 5%, 5%, 5% | 5%, 5%, 5% | 5%, 5%, 5% |
| Slice C | 20%, 25%, 25% | 20%, 20%, 20% | 20%, 35%, 35% | 20%, 30%, 32% | 20%, 30%, 34% |
| Slice D | 20%, 25%, 25% | 20%, 20%, 20% | 20%, 30%, 30% | 20%, 28%, 28% | 20%, 26%, 26% |
| Total | 70%, 80%, 80% | 80%, 80%, 80% | 50%, 75%, 75% | 60%, 78%, 80% | 60, 76%, 80% |

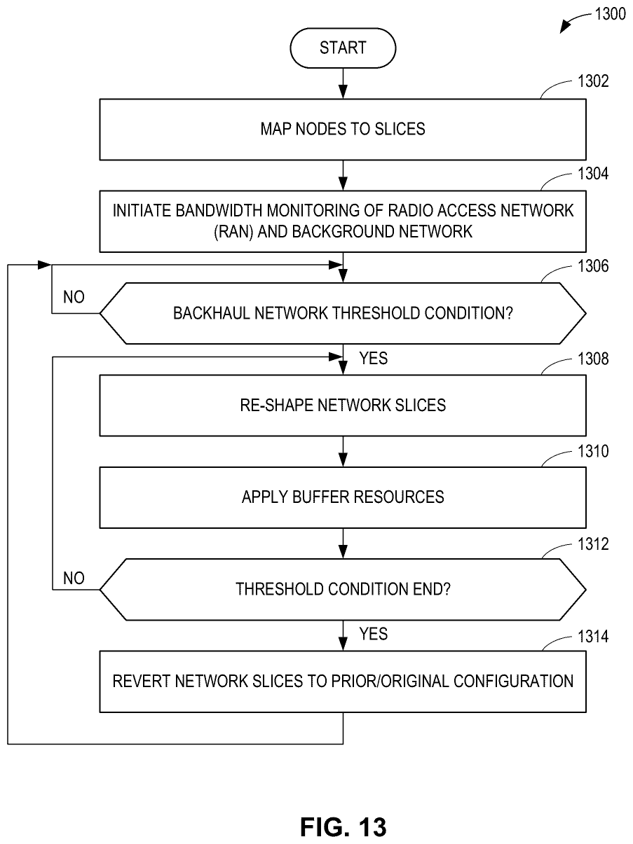

Returning briefly to the illustrated examples of FIGS. 3 and 4, in some examples, the slice definer circuitry 302 is instantiated by programmable circuitry executing slice definer instructions and/or configured to perform operations such as those represented by the flowchart(s) of FIGS. 13-15. In some examples, the performance monitor circuitry 304 is instantiated by programmable circuitry executing performance monitoring instructions and/or configured to perform operations such as those represented by the flowchart(s) of FIGS. 13-15. In some examples, the resource configuration circuitry 306 is instantiated by programmable circuitry executing resource configuration instructions and/or configured to perform operations such as those represented by the flowchart(s) of FIGS. 13-15. In some examples, the resource monitor circuitry 308 is instantiated by programmable circuitry executing resource monitoring instructions and/or configured to perform operations such as those represented by the flowchart(s) of FIGS. 13-15. In some examples, the network control circuitry 102 is instantiated by programmable circuitry executing network controlling instructions and/or configured to perform operations such as those represented by the flowchart(s) of FIGS. 13-15. In some examples, the priority management circuitry 402 is instantiated by programmable circuitry executing priority management instructions and/or configured to perform operations such as those represented by the flowchart(s) of FIGS. 13-15. In some examples, the performance management circuitry 404 is instantiated by programmable circuitry executing performance management instructions and/or configured to perform operations such as those represented by the flowchart(s) of FIGS. 13-15. In some examples, the network control interface circuitry 104 is instantiated by programmable circuitry executing network interface control instructions and/or configured to perform operations such as those represented by the flowchart(s) of FIGS. 13-15.

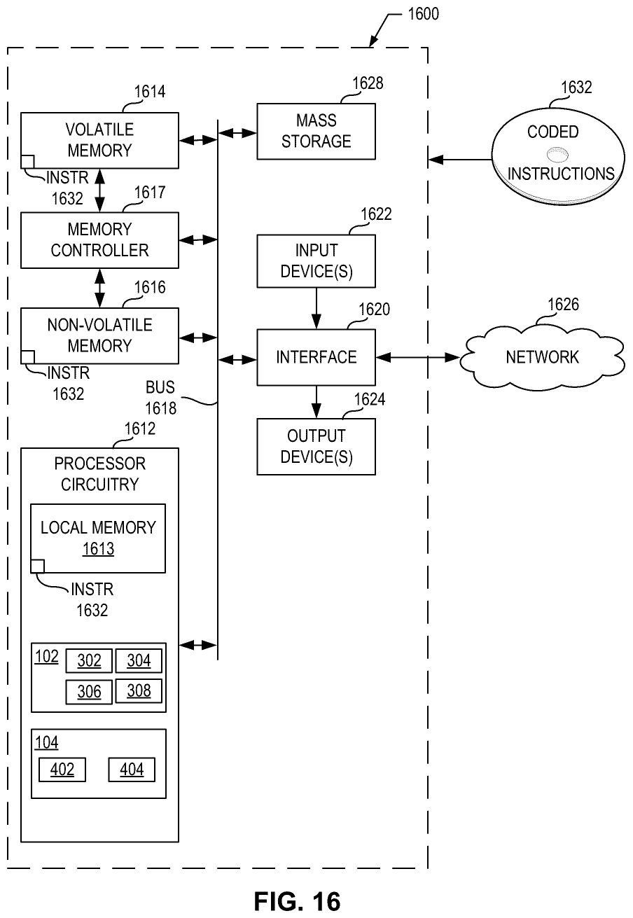

In some examples, the network control circuitry 102 includes means for network control. For example, the means for network control may be implemented by network control circuitry 102. In some examples, the network control circuitry 102 includes means for slice defining. For example, the means for slice defining may be implemented by slice definer circuitry 302. In some examples, the network control circuitry 102 includes means for performance monitoring. For example, the means for performance monitoring may be implemented by performance monitor circuitry 304. In some examples, the network control circuitry 102 includes means for resource configuring. For example, the means for resource configuring may be implemented by resource configuration circuitry 306. In some examples, the network control circuitry 102 includes means for resource monitoring. For example, the means for resource monitoring may be implemented by resource monitor circuitry 308. In some examples, the network control circuitry 102, the slice definer circuitry 302, the performance monitor circuitry 304, the resource configuration circuitry 306 and/or the resource monitor circuitry 308 may be instantiated by programmable circuitry such as the example programmable circuitry 1612 of FIG. 16. For instance, the network control circuitry 102, the slice definer circuitry 302, the performance monitor circuitry 304, the resource configuration circuitry 306 and/or the resource monitor circuitry 308 may be instantiated by the example microprocessor 1700 of FIG.

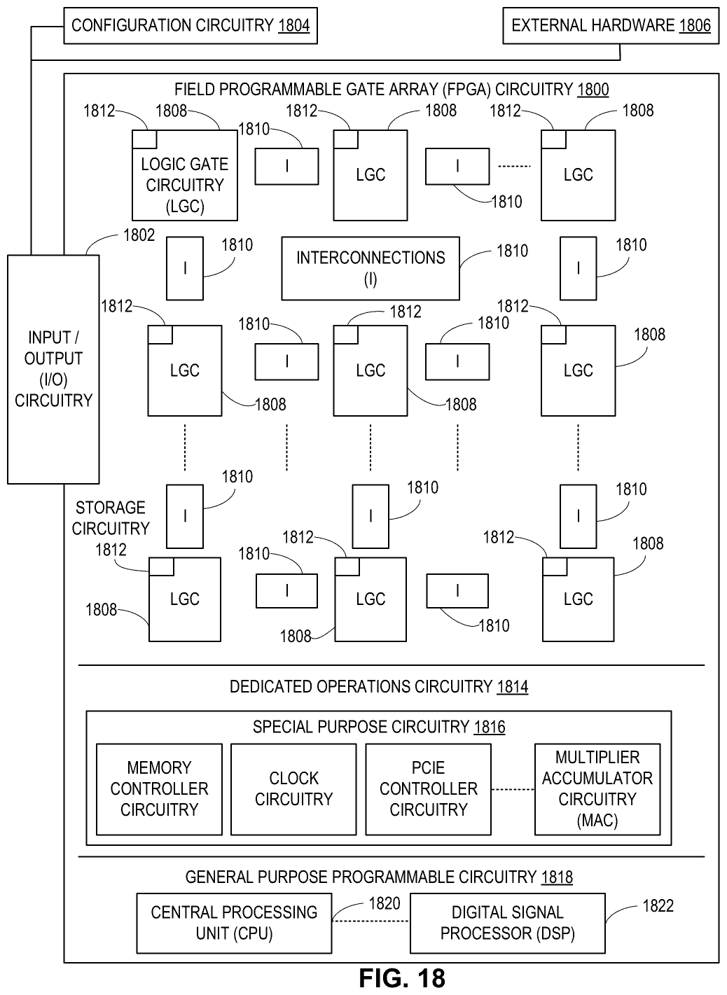

17 executing machine executable instructions such as those implemented by one or more blocks of FIGS. 13-15. In some examples, the network control circuitry 102, the slice definer circuitry 302, the performance monitor circuitry 304, the resource configuration circuitry 306 and/or the resource monitor circuitry 308 may be instantiated by hardware logic circuitry, which may be implemented by an ASIC, XPU, or the FPGA circuitry 1800 of FIG. 18 configured and/or structured to perform operations corresponding to the machine-readable instructions. Additionally or alternatively, the network control circuitry 102, the slice definer circuitry 302, the performance monitor circuitry 304, the resource configuration circuitry 306 and/or the resource monitor circuitry 308 may be instantiated by any other combination of hardware, software, and/or firmware. For example, the network control circuitry 102, the slice definer circuitry 302, the performance monitor circuitry 304, the resource configuration circuitry 306 and/or the resource monitor circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

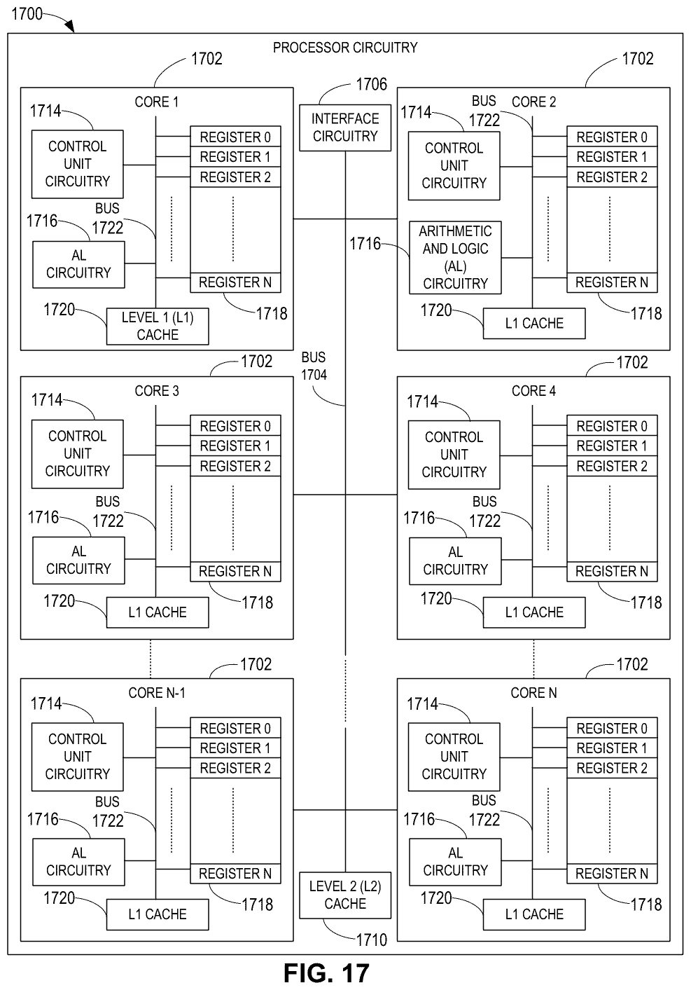

In some examples, the network control interface circuitry 104 includes means for network interfacing. For example, the means for network interfacing may be implemented by network control interface circuitry 104. In some examples, the network control interface circuitry 104 includes means for priority managing. For example, the means for priority managing may be implemented by the priority management circuitry 402. In some examples, the network control interface circuitry 104 includes means for performance managing. For example, the means for performance managing may be implemented by the performance management circuitry 404. In some examples, the network control interface circuitry 104, the priority management circuitry 402 and/or the performance management circuitry 404 may be instantiated by programmable circuitry such as the example programmable circuitry 1612 of FIG. 16. For instance, the network control interface circuitry 104, the priority management circuitry 402 and/or the performance management circuitry 404 may be instantiated by the example microprocessor 1700 of FIG. 17 executing machine executable instructions such as those implemented by one or more blocks of FIGS. 13-15. In some examples, the network control interface circuitry 104, the priority management circuitry 402 and/or the performance management circuitry 404 may be instantiated by hardware logic circuitry, which may be implemented by an ASIC, XPU, or the FPGA circuitry 1800 of FIG. 18 configured and/or structured to perform operations corresponding to the machine-readable instructions. Additionally or alternatively, the network control interface circuitry 104, the priority management circuitry 402 and/or the performance management circuitry 404 may be instantiated by any other combination of hardware, software, and/or firmware. For example, the network control interface circuitry 104, the priority management circuitry 402 and/or the performance management circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the network control circuitry 102 and the network control interface circuitry 104 of FIGS. 1, 2, 5 and 7 is illustrated in FIGS. 3 and 4, one or more of the elements, processes, and/or devices illustrated in FIGS. 3 and/or 4 may be combined, divided, re-arranged, omitted, eliminated, and/or implemented in any other way. Further, the example slice definer circuitry 302, the example performance monitor circuitry 304, the example resource configuration circuitry 306, the example resource monitor circuitry 308, the example priority management circuitry 402, the example performance management circuitry 404, and/or, more generally, the example network control circuitry 102 and/or the example network control interface circuitry 104 of FIGS. 3 and/or 4, may be implemented by hardware alone or by hardware in combination with software and/or firmware. Thus, for example, any of the example slice definer circuitry 302, the example performance monitor circuitry 304, the example resource configuration circuitry 306, the example resource monitor circuitry 308, the example priority management circuitry 402, the example performance management circuitry 404, and/or, more generally, the example network control circuitry 102 and/or the example network control interface circuitry 104 of FIGS. 3 and/or 4, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example network control circuitry 102 and/or the example network control interface circuitry 104 of FIGS. 3 and/or 4 may include one or more elements, processes, and/or devices in addition to, or instead of, those illustrated in FIGS. 3 and/or 4, and/or may include more than one of any or all of the illustrated elements, processes and devices.

Flowchart(s) representative of example machine-readable instructions, which may be executed by programmable circuitry to implement and/or instantiate the network control circuitry 102 and/or the example network control interface circuitry 104 of FIGS. 3 and/or 4 and/or representative of example operations which may be performed by programmable circuitry to implement and/or instantiate the network control circuitry 102 and/or the example network control interface circuitry 104 of

FIGS. 3 and/or 4, are shown in FIGS. 13-15. The machine-readable instructions may be one or more executable programs or portion(s) of one or more executable programs for execution by programmable circuitry such as the programmable circuitry 1612 shown in the example processor platform 1600 discussed below in connection with FIG. 16 and/or may be one or more function(s) or portion(s) of functions to be performed by the example programmable circuitry (e.g., an FPGA) discussed below in connection with FIGS. 17 and/or 18. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 13-15, many other methods of implementing the example network control circuitry 102 and/or the example network control interface circuitry 104 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 13-15 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 13 is a flowchart representative of example machine-readable instructions and/or example operations 1300 that may be executed, instantiated, and/or performed by programmable circuitry to manage network slices. The example machine-readable instructions and/or the example operations 1300 of FIG. 13 begin at block 1302, at which the slice definer circuitry 302 maps network nodes to slices, such as mapping particular UEs of the example UE pool 110 to a slice so that designated network nodes are utilized for that UE in an effort to guarantee QoS objectives. The example performance monitor circuitry 304 initiates performance metric monitoring of the radio access network (RAN) 106 and the backhaul network 108 (block 1304), and determines whether the backhaul network 108 is experiencing a network threshold condition (block 1306). If not, monitoring continues to identify such a circumstance.

In the event the performance monitor circuitry 304 determines, identifies and/or otherwise detects that the backhaul network 108 is experiencing a network threshold condition (block 1306), then the slice definer circuitry 302 reshapes and/or otherwise re-configures one or more slices that is responsible for traffic over the backhaul network (block 1308). To further reduce one or more burdens on the backhaul network 108, which may be receiving a bandwidth quantity in excess of its capabilities due to a data dump, the example resource configuration circuitry 306 applies buffer resources 310 that may be available (block 1310). For instance, the slice definer circuity 302 may reshape a network slice by causing one or more participating network nodes of the slice to reduce data generating characteristics, such as reducing a rate of data transmission, or reducing a resolution of transmitted data. In some examples, the resource configuration circuitry 306 prevents loss of data during the data reducing initiatives by causing some of the data that would otherwise be directed via the backhaul network to instead be directed to one or more buffer resources 310. After any network congestion issues have been resolved and/or the backhaul network 108 is operating within its capabilities (block 1312), data stored in the buffer resources 310 may be transmitted via the backhaul network 108 and the example slice definer circuitry 302 reverts the reshaped network slices in a manner consistent with their prior and/or otherwise original configuration (block 1314).

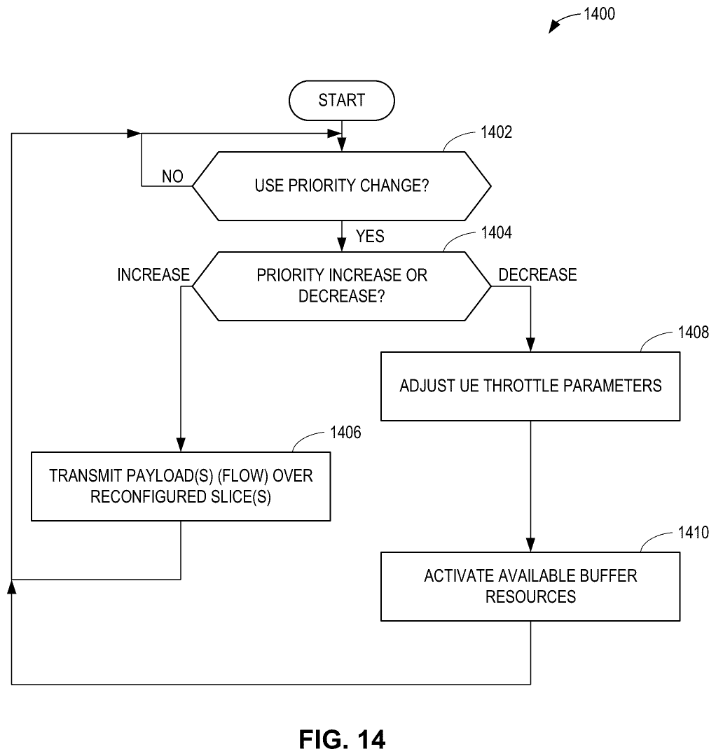

While the illustrated example of FIG. 13 described example instructions, tasks and/or services from a point-of-view of the example network control circuitry 102, FIG. 14 is a flowchart of example operations 1400 to manage network slices from a point-of-view of an example UE. In the illustrated example of FIG. 14, the priority management circuitry 402 determines whether the UE has initiated and/or otherwise detected a priority change (block 1402). If not, the priority management circuitry 402 continues to monitor the UE for such a condition change. As described above, each participating UE may have capabilities to manage its own operating priority, such as a relatively low priority value (e.g., 0) when an urgency metric of data transmission can accommodate a best effort transmission scheme. On the other hand, in the event a relatively higher priority value is associated with the UE (e.g., 10), then the urgency metric suggests that efforts should be increased to make sure the data is transmitted relatively sooner (e.g., in view of safety issues, property damage, etc.).

When the example priority management circuitry 402 detects a priority change of the UE (block 1402), it determines whether the priority change is increased or decreased (block 1404). For instance, if the priority change is increased, then the network controller interface circuitry 104 transmits payload information in a relatively more urgent and fast manner via a reconfigured slice (block 1406). In some examples, the UE transmits a slice reconfiguration request when a relative priority value increases. Prior to transmitting the payload data, the UE waits for an acknowledgement (e.g., from the example network control circuitry 102) that a reconfigured slice is available. When the example priority management circuitry 402 detects a priority decrease (block 1402), then the example performance management circuitry 404 adjusts UE throttle parameters (block 1408) and activates any available buffer resources 410 (block 1410) that might be available to store some payload data in an effort to reduce a downstream bandwidth burden on the backhaul network 108.

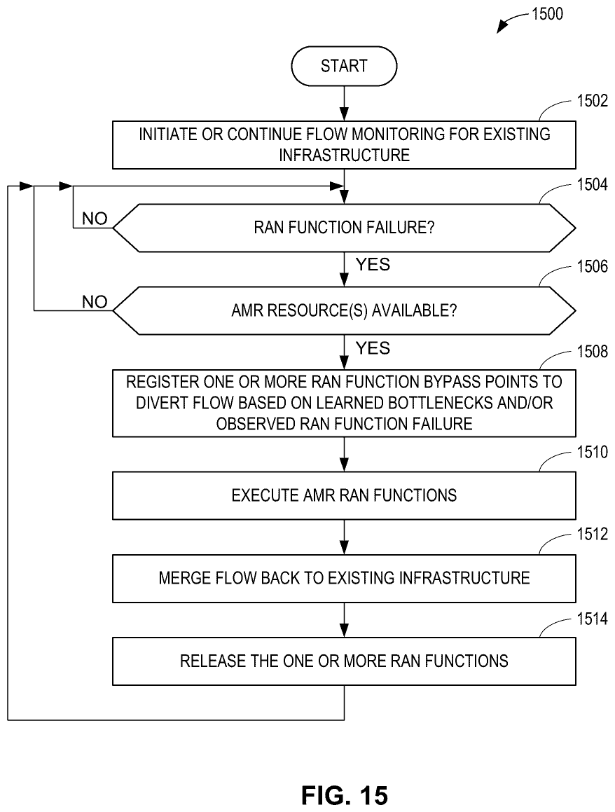

FIG. 15 is a flowchart of example operations 1500 to manage network slices when autonomous mobile robot (AMR) resources are available. In the illustrated example of FIG. 15, the performance monitor circuitry 304 initiates or continues flow monitoring tasks for an existing infrastructure (block 1502), such as a native radio access network (RAN) in a particular geography. As described above, the native RAN may be a static assembly of network nodes for a particular type of network technology, such as 5G, but examples disclosed herein are not limited thereto. The example performance monitor circuitry 304 determines whether one or more RAN function failures have occurred (block 1504) and, if so, the example resource monitor circuitry 308 determines whether AMR resources are available (block 1506).

In the event the resource monitor circuitry 308 determines that AMR resources are available (block 1506), it registers one or more RAN function bypass points to divert flow based on learned bottlenecks and/or observed RAN function failures of the native RAN (block 1508). The resource monitor circuitry 308 causes the AMR to serve-up its available function(s) for execution (block 1510) and, when completed, causes a merge of the flow back to the existing/native infrastructure (block 1512). The resource monitor circuitry 308 then releases the one or more RAN functions from the AMR (block 1514) so that they are available by one or more other native RAN failure occurrences in the future.

FIG. 16 is a block diagram of an example programmable circuitry platform 1600 structured to execute and/or instantiate the example machine-readable instructions and/or the example operations of FIGS. 13-15 to implement the network control circuitry 102 and/or the network control interface circuitry of FIGS. 3 and/or 4. The programmable circuitry platform 1600 can be, for example, a server, a personal computer, a workstation, a self-learning machine (e.g., a neural network), a mobile device (e.g., a cell phone, a smart phone, a tablet such as an iPad™), an Internet appliance, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1600 of the illustrated example includes programmable circuitry 1612. The programmable circuitry 1612 of the illustrated example is hardware. For example, the programmable circuitry 1612 can be implemented by one or more integrated circuits, logic circuits, FPGAs, microprocessors, CPUs, GPUs, DSPs, and/or microcontrollers from any desired family or manufacturer. The programmable circuitry 1612 may be implemented by one or more semiconductor based (e.g., silicon based) devices. In this example, the programmable circuitry 1612 implements the example slice definer circuitry 302, the example performance monitor circuitry 304, the example resource configuration circuitry 306, the example resource monitor circuitry 308, the example priority management circuitry 402, the example performance management circuitry 404, the example network control circuitry 102 and the example network control interface circuitry 104.

The programmable circuitry 1612 of the illustrated example includes a local memory 1613 (e.g., a cache, registers, etc.). The programmable circuitry 1612 of the illustrated example is in communication with main memory 1614, 1616, which includes a volatile memory 1614 and a non-volatile memory 1616, by a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1616 may be implemented by flash memory and/or any other desired type of memory device. Access to the main memory 1614, 1616 of the illustrated example is controlled by a memory controller 1617. In some examples, the memory controller 1617 may be implemented by one or more integrated circuits, logic circuits, microcontrollers from any desired family or manufacturer, or any other type of circuitry to manage the flow of data going to and from the main memory 1614, 1616.

The programmable circuitry platform 1600 of the illustrated example also includes interface circuitry 1620. The interface circuitry 1620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1622 are connected to the interface circuitry 1620. The input device(s) 1622 permit(s) a user (e.g., a human user, a machine user, etc.) to enter data and/or commands into the programmable circuitry 1612. The input device(s) 1622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1624 are also connected to the interface circuitry 1620 of the illustrated example. The output device(s) 1624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1620 of the illustrated example, thus, typically includes a graphics driver card, a graphics driver chip, and/or graphics processor circuitry such as a GPU.

The interface circuitry 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1600 of the illustrated example also includes one or more mass storage discs or devices 1628 to store firmware, software, and/or data. Examples of such mass storage discs or devices 1628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1632, which may be implemented by the machine-readable instructions of FIGS. 13-15, may be stored in the mass storage device 1628, in the volatile memory 1614, in the non-volatile memory 1616, and/or on at least one non-transitory computer readable storage medium such as a CD or DVD which may be removable.

FIG. 17 is a block diagram of an example implementation of the programmable circuitry 1612 of FIG. 16. In this example, the programmable circuitry 1612 of FIG. 16 is implemented by a microprocessor 1700. For example, the microprocessor 1700 may be a general-purpose microprocessor (e.g., general-purpose microprocessor circuitry). The microprocessor 1700 executes some or all of the machine-readable instructions of the flowcharts of FIGS. 13-15 to effectively instantiate the circuitry of FIG. 2 as logic circuits to perform operations corresponding to those machine-readable instructions. In some such examples, the circuitry of FIGS. 3 and/or 4 is instantiated by the hardware circuits of the microprocessor 1700 in combination with the machine-readable instructions. For example, the microprocessor 1700 may be implemented by multi-core hardware circuitry such as a CPU, a DSP, a GPU, an XPU, etc. Although it may include any number of example cores 1702 (e.g., 1 core), the microprocessor 1700 of this example is a multi-core semiconductor device including N cores. The cores 1702 of the microprocessor 1700 may operate independently or may cooperate to execute machine-readable instructions. For example, machine code corresponding to a firmware program, an embedded software program, or a software program may be executed by one of the cores 1702 or may be executed by multiple ones of the cores 1702 at the same or different times. In some examples, the machine code corresponding to the firmware program, the embedded software program, or the software program is split into threads and executed in parallel by two or more of the cores 1702. The software program may correspond to a portion or all of the machine-readable instructions and/or operations represented by the flowcharts of FIGS. 13-15.

The cores 1702 may communicate by a first example bus 1704. In some examples, the first bus 1704 may be implemented by a communication bus to effectuate communication associated with one(s) of the cores 1702. For example, the first bus 1704 may be implemented by at least one of an Inter-Integrated Circuit (I2C) bus, a Serial Peripheral Interface (SPI) bus, a PCI bus, or a PCIe bus. Additionally or alternatively, the first bus 1704 may be implemented by any other type of computing or electrical bus. The cores 1702 may obtain data, instructions, and/or signals from one or more external devices by example interface circuitry 1706. The cores 1702 may output data, instructions, and/or signals to the one or more external devices by the interface circuitry 1706. Although the cores 1702 of this example include example local memory 1720 (e.g., Level 1 (L1) cache that may be split into an L1 data cache and an L1 instruction cache), the microprocessor 1700 also includes example shared memory 1710 that may be shared by the cores (e.g., Level 2 (L2 cache)) for high-speed access to data and/or instructions. Data and/or instructions may be transferred (e.g., shared) by writing to and/or reading from the shared memory 1710. The local memory 1720 of each of the cores 1702 and the shared memory 1710 may be part of a hierarchy of storage devices including multiple levels of cache memory and the main memory (e.g., the main memory 1614, 1616 of FIG. 16). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1702 may be referred to as a CPU, DSP, GPU, etc., or any other type of hardware circuitry. Each core 1702 includes control unit circuitry 1714, arithmetic and logic (AL) circuitry (sometimes referred to as an ALU) 1716, a plurality of registers 1718, the local memory 1720, and a second example bus 1722. Other structures may be present. For example, each core 1702 may include vector unit circuitry, single instruction multiple data (SIMD) unit circuitry, load/store unit (LSU) circuitry, branch/jump unit circuitry, floating-point unit (FPU) circuitry, etc. The control unit circuitry 1714 includes semiconductor-based circuits structured to control (e.g., coordinate) data movement within the corresponding core 1702. The AL circuitry 1716 includes semiconductor-based circuits structured to perform one or more mathematic and/or logic operations on the data within the corresponding core 1702. The AL circuitry 1716 of some examples performs integer based operations. In other examples, the AL circuitry 1716 also performs floating-point operations. In yet other examples, the AL circuitry 1716 may include first AL circuitry that performs integer-based operations and second AL circuitry that performs floating-point operations. In some examples, the AL circuitry 1716 may be referred to as an Arithmetic Logic Unit (ALU).

The registers 1718 are semiconductor-based structures to store data and/or instructions such as results of one or more of the operations performed by the AL circuitry 1716 of the corresponding core 1702. For example, the registers 1718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1718 may be arranged in a bank as shown in FIG. 17. Alternatively, the registers 1718 may be organized in any other arrangement, format, or structure, such as by being distributed throughout the core 1702 to shorten access time. The second bus 1722 may be implemented by at least one of an I2C bus, a SPI bus, a PCI bus, or a PCle bus.

Each core 1702 and/or, more generally, the microprocessor 1700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1700 is a semiconductor device fabricated to include many transistors interconnected to implement the structures described above in one or more integrated circuits (ICs) contained in one or more packages.

The microprocessor 1700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1700, in the same chip package as the microprocessor 1700 and/or in one or more separate packages from the microprocessor 1700.

FIG. 18 is a block diagram of another example implementation of the programmable circuitry 1612 of FIG. 16. In this example, the programmable circuitry 1612 is implemented by FPGA circuitry 1800. For example, the FPGA circuitry 1800 may be implemented by an FPGA. The FPGA circuitry 1800 can be used, for example, to perform operations that could otherwise be performed by the example microprocessor 1700 of FIG. 17 executing corresponding machine-readable instructions. However, once configured, the FPGA circuitry 1800 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1700 of FIG. 17 described above (which is a general purpose device that may be programmed to execute some or all of the machine-readable instructions represented by the flowchart(s) of FIGS. 13-15 but whose interconnections and logic circuitry are fixed once fabricated), the FPGA circuitry 1800 of the example of FIG. 18 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 13-15. In particular, the FPGA circuitry 1800 may be thought of as an array of logic gates, interconnections, and switches. The switches can be programmed to change how the logic gates are interconnected by the interconnections, effectively forming one or more dedicated logic circuits (unless and until the FPGA circuitry 1800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 13-15. As such, the FPGA circuitry 1800 may be configured and/or structured to effectively instantiate some or all of the operations/functions corresponding to the machine-readable instructions of the flowchart(s) of FIGS. 13-15 as dedicated logic circuits to perform the operations/functions corresponding to those software instructions in a dedicated manner analogous to an ASIC. Therefore, the FPGA circuitry 1800 may perform the operations/functions corresponding to the some or all of the machine-readable instructions of FIGS. 13-15 faster than the general-purpose microprocessor can execute the same.

In the example of FIG. 18, the FPGA circuitry 1800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1800 of FIG. 18 may access and/or load the binary file to cause the FPGA circuitry 1800 of FIG. 18 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1800 of FIG. 18 to cause configuration and/or structuring of the FPGA circuitry 1800 of FIG. 18, or portion(s) thereof.

The FPGA circuitry 1800 of FIG. 18, includes example input/output (I/O) circuitry 1802 to obtain and/or output data to/from example configuration circuitry 1804 and/or external hardware 1806. For example, the configuration circuitry 1804 may be implemented by interface circuitry that may obtain a binary file, which may be implemented by a bit stream, data, and/or machine-readable instructions, to configure the FPGA circuitry 1800, or portion(s) thereof. In some such examples, the configuration circuitry 1804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1806 may be implemented by external hardware circuitry. For example, the external hardware 1806 may be implemented by the microprocessor 1700 of FIG. 17.

The FPGA circuitry 1800 also includes an array of example logic gate circuitry 1808, a plurality of example configurable interconnections 1810, and example storage circuitry 1812. The logic gate circuitry 1808 and the configurable interconnections 1810 are configurable to instantiate one or more operations/functions that may correspond to at least some of the machine-readable instructions of FIGS. 13-15 and/or other desired operations. The logic gate circuitry 1808 shown in FIG. 18 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1808 to enable configuration of the electrical structures and/or the logic gates to form circuits to perform desired operations/functions. The logic gate circuitry 1808 may include other electrical structures such as look-up tables (LUTs), registers (e.g., flip-flops or latches), multiplexers, etc.

The configurable interconnections 1810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1808 to program desired logic circuits.

The storage circuitry 1812 of the illustrated example is structured to store result(s) of the one or more of the operations performed by corresponding logic gates. The storage circuitry 1812 may be implemented by registers or the like. In the illustrated example, the storage circuitry 1812 is distributed amongst the logic gate circuitry 1808 to facilitate access and increase execution speed.

The example FPGA circuitry 1800 of FIG. 18 also includes example dedicated operations circuitry 1814. In this example, the dedicated operations circuitry 1814 includes special purpose circuitry 1816 that may be invoked to implement commonly used functions to avoid the need to program those functions in the field. Examples of such special purpose circuitry 1816 include memory (e.g., DRAM) controller circuitry, PCle controller circuitry, clock circuitry, transceiver circuitry, memory, and multiplier-accumulator circuitry. Other types of special purpose circuitry may be present. In some examples, the FPGA circuitry 1800 may also include example general purpose programmable circuitry 1818 such as an example CPU 1820 and/or an example DSP 1822. Other general purpose programmable circuitry 1818 may additionally or alternatively be present such as a GPU, an XPU, etc., that can be programmed to perform other operations.

Although FIGS. 17 and 18 illustrate two example

implementations of the programmable circuitry 1612 of FIG. 16, many other approaches are contemplated. For example, FPGA circuitry may include an on-board CPU, such as one or more of the example CPU 1820 of FIG. 17. Therefore, the programmable circuitry 1612 of FIG. 16 may additionally be implemented by combining at least the example microprocessor 1700 of FIG. 17 and the example FPGA circuitry 1800 of FIG. 18. In some such hybrid examples, one or more cores 1702 of FIG. 17 may execute a first portion of the machine-readable instructions represented by the flowchart(s) of FIGS. 13-15 to perform first operation(s)/function(s), the FPGA circuitry 1800 of FIG. 18 may be configured and/or structured to perform second operation(s)/function(s) corresponding to a second portion of the machine-readable instructions represented by the flowcharts of FIG. 13-15, and/or an ASIC may be configured and/or structured to perform third operation(s)/function(s) corresponding to a third portion of the machine-readable instructions represented by the flowcharts of FIGS. 13-15.

It should be understood that some or all of the circuitry of FIGS. 3 and/or 4 may, thus, be instantiated at the same or different times. For example, same and/or different portion(s) of the microprocessor 1700 of FIG. 17 may be programmed to execute portion(s) of machine-readable instructions at the same and/or different times. In some examples, same and/or different portion(s) of the FPGA circuitry 1800 of FIG. 18 may be configured and/or structured to perform operations/functions corresponding to portion(s) of machine-readable instructions at the same and/or different times.

In some examples, some or all of the circuitry of FIGS. 3 and/or 4 may be instantiated, for example, in one or more threads executing concurrently and/or in series. For example, the microprocessor 1700 of FIG. 17 may execute machine-readable instructions in one or more threads executing concurrently and/or in series. In some examples, the FPGA circuitry 1800 of FIG. 18 may be configured and/or structured to carry out operations/functions concurrently and/or in series. Moreover, in some examples, some or all of the circuitry of FIGS. 3 and/or 4 may be implemented within one or more virtual machines and/or containers executing on the microprocessor 1700 of FIG. 17.

In some examples, the programmable circuitry 1612 of FIG. 16 may be in one or more packages. For example, the microprocessor 1700 of FIG. 17 and/or the FPGA circuitry 1800 of FIG. 18 may be in one or more packages. In some examples, an XPU may be implemented by the programmable circuitry 1612 of FIG. 16, which may be in one or more packages. For example, the XPU may include a CPU (e.g., the microprocessor 1700 of FIG. 17, the CPU 1820 of FIG. 18, etc.) in one package, a DSP (e.g., the DSP 1822 of FIG. 18) in another package, a GPU in yet another package, and an FPGA (e.g., the FPGA circuitry 1800 of FIG. 18) in still yet another package.

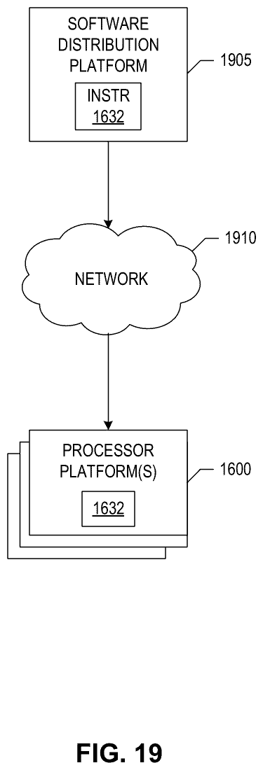

A block diagram illustrating an example software distribution platform 1905 to distribute software such as the example machine-readable instructions 1632 of FIG. 16 to other hardware devices (e.g., hardware devices owned and/or operated by third parties from the owner and/or operator of the software distribution platform) is illustrated in FIG. 19. The example software distribution platform 1905 may be implemented by any computer server, data facility, cloud service, etc., capable of storing and transmitting software to other computing devices. The third parties may be customers of the entity owning and/or operating the software distribution platform 1905. For example, the entity that owns and/or operates the software distribution platform 1905 may be a developer, a seller, and/or a licensor of software such as the example machine-readable instructions 1632 of FIG. 16. The third parties may be consumers, users, retailers, OEMs, etc., who purchase and/or license the software for use and/or re-sale and/or sub-licensing. In the illustrated example, the software distribution platform 1905 includes one or more servers and one or more storage devices. The storage devices store the machine-readable instructions 1632, which may correspond to the example machine-readable instructions of FIGS. 13-15, as described above. The one or more servers of the example software distribution platform 1905 are in communication with an example network 1910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1632 from the software distribution platform 1905. For example, the software, which may correspond to the example machine-readable instructions of FIG. 13-15, may be downloaded to the example programmable circuitry platform 1600, which is to execute the machine-readable instructions 1632 to implement the network control circuitry 102 and/or the network control interface circuitry 104. In some examples, one or more servers of the software distribution platform 1905 periodically offer, transmit, and/or force updates to the software (e.g., the example machine-readable instructions 1632 of FIG. 16) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one

A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of ±10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time of ±1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that manage network slices. In some examples disclosed herein, a balance is established between overprovisioning network resources to guarantee acceptable quality of service expectations and waste that results from non-use of overprovisioned network resources. Example slice reshaping disclosed herein borrows network resources from other nodes that have preconfigured resource dedication, and reverts such borrowed resources back to the donating nodes when demands recede. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to manage network slices are disclosed herein. Further examples and combinations thereof include the following:

Example 1 includes a method for managing radio resources in a network slicing environment, comprising reserving radio resources for network slicing to meet predetermined service level objectives (SLOs), dynamically adjusting the reservations of radio resources based on real-time traffic loads, requesting one or more in-range base stations to take over traffic when a current load exceeds a threshold value, and incorporating end-to-end considerations by preemptively dropping traffic at the current network node if telemetry indicates that the traffic would be dropped at a subsequent hop in a network path.

Example 2 includes the method as defined in example 1, further including utilizing artificial intelligence/machine learning (AI/ML) algorithms to determine the adjustments to the radio resource reservations based on predictive analysis of traffic patterns and network conditions, and orchestrate movement and deployment of an autonomous mobile robot (AMR) to improve network coverage and capacity in response to real-time and forecasted traffic demands.

Example 3 includes the method as defined in any of examples 1 or 2, further including deploying an autonomous mobile robot (AMR) equipped with radio access capabilities to enter the range and support traffic handling when other base stations are unable to take over the traffic.

Example 4 includes the method as defined in example 3, wherein the AMR includes at least one of ground-based resources, air-based resources or water-based resources.

Example 5 includes the method as defined in example 3, wherein the AMR operates in at least one of a tethered mode or an untethered mode.

Example 6 includes an apparatus comprising interface circuitry to acquire network information, machine-readable instructions, and at least one processor circuit to be programmed by the machine-readable instructions to reserve first network slices to satisfy service level objectives (SLOs) corresponding to first nodes, reserve second network slices to satisfy SLOs corresponding to second nodes, and reconfigure the first network slices to accept network communications from the second nodes when the network communications from the second nodes exceed a performance metric threshold.

Example 7 includes the apparatus as defined in example 6, wherein the performance metric threshold corresponds to a bandwidth threshold associated with a combined bandwidth of the network communications from the second nodes and network communications from the first nodes.

Example 8 includes the apparatus as defined in example 7, wherein the combined bandwidth traverses a first network of the first nodes and a second network of the second nodes.

Example 9 includes the apparatus as defined in example 8, wherein the first network corresponds to a radio access network (RAN) and the second network corresponds to a backhaul network.

Example 10 includes the apparatus as defined in any of examples 8 or 9, wherein one or more of the at least one processor circuit is to adjust one or more of the first nodes to reduce a data acquisition rate.

Example 11 includes the apparatus as defined in any of examples 8, 9, or 10, wherein one or more of the at least one processor circuit is to reduce an image resolution corresponding to image capture tasks of the one or more of the first nodes.

Example 12 includes the apparatus as defined in any of examples 8, 9, 10, or 11, wherein one or more of the at least one processor circuit is to store data corresponding to the first network in a buffer to temporarily reduce network traffic.

Example 13 includes the apparatus as defined in any of examples 6, 7, or 8, wherein one or more of the at least one processor circuit is to detect autonomous mobile robot (AMR) network resources after a network function failure corresponding to a first network.

Example 14 includes the apparatus as defined in example 13, wherein one or more of the at least one processor circuit is to identify a bypass exit point of the first network, divert the network communication from the first network via the bypass exit point, and cause the AMR network resources to process the diverted network communication.

Example 15 includes At least one non-transitory machine-readable medium comprising machine-readable instructions to cause at least one processor circuit to at least reserve first network slices to satisfy first service level objectives (SLOs) corresponding to first network nodes, reserve second network slices to satisfy second SLOs corresponding to second network nodes, and reconfigure the first network slices to accept network flow from the second network nodes when the network flow from the second network nodes exceeds a performance metric threshold.

Example 16 includes the at least one non-transitory machine- readable medium as defined in example 15, wherein the machine-readable instructions are to cause one or more of the at least one processor circuit to measure the performance metric threshold based on a combined bandwidth of the network flow from the second network nodes and network flow from the first network nodes.

Example 17 includes the at least one non-transitory machine-readable medium as defined in any of examples 15 or 16, wherein the machine-readable instructions are to cause one or more of the at least one processor circuit to adjust one or more of the first network nodes to reduce a data acquisition rate.

Example 18 includes the at least one non-transitory machine-readable medium as defined in any of examples 15, 16 or 17, wherein the machine-readable instructions are to cause one or more of the at least one processor circuit to reduce an image resolution corresponding to image capture tasks of the one or more first network nodes.

Example 19 includes the at least one non-transitory machine-readable medium as defined in example 15, wherein the machine-readable instructions are to cause one or more of the at least one processor circuit to store data corresponding to the first network nodes of a first network, the first network to provide the network flow to the second network nodes of a second network.

Example 20 includes the at least one non-transitory machine-readable medium as defined in example 19, wherein the machine-readable instructions are to cause one or more of the at least one processor circuit to store the data in buffer resources to temporarily reduce traffic in the second network.

Example 21 includes the at least one non-transitory machine-readable medium as defined in example 15, wherein the machine-readable instructions are to cause one or more of the at least one processor circuit to detect autonomous mobile robot (AMR) network resources after a network function failure corresponding to a first network.

Example 22 includes the at least one non-transitory machine-readable medium as defined in example 21, wherein the machine-readable instructions are to cause one or more of the at least one processor circuit to identify a bypass exit point of the first network, divert network flow from the first network to the AMR network resources via the bypass exit point, and cause the AMR network resources to process the diverted network flow.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A method for managing radio resources in a network slicing environment, comprising:
reserving radio resources for network slicing to meet predetermined service level objectives (SLOs);
dynamically adjusting the reservations of radio resources based on real-time traffic loads;
requesting one or more in-range base stations to carry traffic when a current load satisfies a threshold value; and
incorporating end-to-end considerations by dropping traffic at the current network node if telemetry indicates that the traffic would be dropped at a subsequent hop in a network path.

2. The method as defined in claim 1, further including utilizing artificial intelligence/machine learning (AI/ML) algorithms to:
determine the adjustments to the radio resource reservations based on predictive analysis of traffic patterns and network conditions; and
orchestrate movement and deployment of an autonomous mobile robot (AMR) to improve network coverage and capacity in response to real-time and forecasted traffic demands.

3. The method as defined in claim 1, further including deploying an autonomous mobile robot (AMR) equipped with radio access capabilities to enter the range and support traffic handling when other base stations are unable to take over the traffic.

4. The method as defined in claim 3, wherein the AMR includes at least one of ground-based resources, air-based resources or water-based resources.

5. The method as defined in claim 3, wherein the AMR operates in at least one of a tethered mode or an untethered mode.

6. An apparatus comprising:
interface circuitry to acquire network information;
machine-readable instructions; and
at least one processor circuit to be programmed by the machine-readable instructions to:
reserve first network slices to satisfy service level objectives (SLOs) corresponding to first nodes;
reserve second network slices to satisfy SLOs corresponding to second nodes; and
reconfigure the first network slices to accept network communications from the second nodes when the network communications from the second nodes exceed a performance metric threshold.

7. The apparatus as defined in claim 6, wherein the performance metric threshold corresponds to a bandwidth threshold associated with a combined bandwidth of the network communications from the second nodes and network communications from the first nodes.

8. The apparatus as defined in claim 7, wherein the combined bandwidth traverses a first network of the first nodes and a second network of the second nodes.

9. The apparatus as defined in claim 8, wherein the first network corresponds to a radio access network (RAN) and the second network corresponds to a backhaul network.

10. The apparatus as defined in claim 8, wherein one or more of the at least one processor circuit is to adjust one or more of the first nodes to reduce a data acquisition rate.

11. The apparatus as defined in claim 8, wherein one or more of the at least one processor circuit is to reduce an image resolution corresponding to image capture tasks of the one or more of the first nodes.

12. The apparatus as defined in claim 8, wherein one or more of the at least one processor circuit is to store data corresponding to the first network in a buffer to temporarily reduce network traffic.

13. The apparatus as defined in claim 6, wherein one or more of the at least one processor circuit is to detect autonomous mobile robot (AMR) network resources after a network function failure corresponding to a first network.

14. The apparatus as defined in claim 13, wherein one or more of the at least one processor circuit is to:
identify a bypass exit point of the first network;
divert the network communication from the first network via the bypass exit point; and
cause the AMR network resources to process the diverted network communication.

15. At least one non-transitory machine-readable medium comprising machine-readable instructions to cause at least one processor circuit to at least:
reserve first network slices to satisfy first service level objectives (SLOs) corresponding to first network nodes;
reserve second network slices to satisfy second SLOs corresponding to second network nodes; and
reconfigure the first network slices to accept network flow from the second network nodes when the network flow from the second network nodes exceeds a performance metric threshold.

16. The at least one non-transitory machine-readable medium as defined in claim 15, wherein the machine-readable instructions are to cause one or more of the at least one processor circuit to measure the performance metric threshold based on a combined bandwidth of the network flow from the second network nodes and network flow from the first network nodes.

17. The at least one non-transitory machine-readable medium as defined in claim 15, wherein the machine-readable instructions are to cause one or more of the at least one processor circuit to adjust one or more of the first network nodes to reduce a data acquisition rate.

18. The at least one non-transitory machine-readable medium as defined in claim 15, wherein the machine-readable instructions are to cause one or more of the at least one processor circuit to reduce an image resolution corresponding to image capture tasks of the one or more first network nodes.

19. The at least one non-transitory machine-readable medium as defined in claim 15, wherein the machine-readable instructions are to cause one or more of the at least one processor circuit to store data corresponding to the first network nodes of a first network, the first network to provide the network flow to the second network nodes of a second network.

20. The at least one non-transitory machine-readable medium as defined in claim 19, wherein the machine-readable instructions are to cause one or more of the at least one processor circuit to store the data in buffer resources to temporarily reduce traffic in the second network.

21. The at least one non-transitory machine-readable medium as defined in claim 15, wherein the machine-readable instructions are to cause one or more of the at least one processor circuit to detect autonomous mobile robot (AMR) network resources after a network function failure corresponding to a first network.

22. The at least one non-transitory machine-readable medium as defined in claim 21, wherein the machine-readable instructions are to cause one or more of the at least one processor circuit to:
identify a bypass exit point of the first network;
divert network flow from the first network to the AMR network resources via the bypass exit point; and
cause the AMR network resources to process the diverted network flow.

23. The at least one non-transitory machine-readable medium as defined in claim 22, wherein the machine-readable instructions are to cause one or more of the at least one processor circuit to merge the processed diverted network flow back to the first network.
